(19) United States
(12) Patent Application Publication
(10) Pub. No.: US 2025/0356211 A1
(43) Pub. Date: Nov. 20, 2025

(54) ATTENTION MASK FOR SIMULTANEOUS TRANSLATION WITH POSITIONAL REORDERING

(71) Applicant: Oregon State University, Corvallis, OR (US)

(72) Inventors: Lizhong Chen, Corvallis, OR (US); Matthew Emilio Raffel, Corvallis, OR (US)

(73) Assignee: Oregon State University, Corvallis, OR (US)

(21) Appl. No.: 19/071,095

(22) Filed: Mar. 5, 2025

Related U.S. Application Data
(60) Provisional application No. 63/647,488, filed on May 14, 2024.

(51) Int. Cl. G06N 3/096

(52) U.S. Cl. CPC G06N 3/096

(57) ABSTRACT

A computer-implemented method for fine-tuning an autoregressive large language model (LLM) for simultaneous translation is disclosed. The method can receive an input vector comprising a plurality of tokens including source tokens representing a source sequence, a prompt, and target tokens representing a target sequence. The method can train the LLM using the input vector based on a self-attention mechanism, including generating an attention matrix comprising attentions derived from the input vector, and applying an attention mask to the attention matrix. Some entries of the attention mask have a mask indicator indicating corresponding attentions are masked, while other entries of the attention mask have a no-mask indicator indicating corresponding attentions are not masked. The training also includes applying biases to attentions in the attention mask corresponding to no-mask indicators in the attention mask. For each row of the attention matrix, the applied biases increase linearly from left to right.

### CROSS-REFERENCE TO RELATED APPLICATIONS

This application claims the benefit of U.S. Provisional Patent Application No. 63/647,488, filed May 14, 2024, which is incorporated herein by reference in its entirety.

### ACKNOWLEDGMENT OF GOVERNMENT SUPPORT

This invention was made with government support under Award Number 2223483 awarded by the National Science Foundation. The government has certain rights in the invention.

### FIELD

The present disclosure concerns methods and systems for simultaneous translation using generative artificial intelligence.

### BACKGROUND

Large language models (LLMs) have achieved state-of-the-art performance in various language processing tasks, motivating their adoption in simultaneous translation. Current fine-tuning methods to adapt LLMs for simultaneous translation focus on prompting optimization strategies using either data augmentation or prompt structure modifications. However, these methods either neglect the computational inefficiency from dumping the key-value (KV) caching, unnecessarily expanding the training set, increasing prompt sizes, or are restrictive to a single decision policy. Thus, there is a room for improvement of computational efficiency for simultaneous translation.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Certain aspects of the disclosure concern a computing system for fine-tuning an autoregressive LLM for simultaneous translation. The computing system includes memory; one or more hardware processors coupled to the memory; and one or more non-transitory computer readable storage media storing instructions that, when loaded into the memory, cause the one or more hardware processors to perform operations comprising: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: obtaining a plurality of queries and a plurality of keys respectively corresponding to the plurality of tokens in the input vector; generating an L×L attention matrix, wherein L represents a dimension of the input vector, wherein the attention matrix comprises attentions calculated as dot products of the plurality of queries and the plurality of keys; and applying an attention mask to the attention matrix, wherein the attention mask is configured to mask selected attentions from the attention matrix based on a read-write decision policy, wherein the read-write decision policy specifies how many source tokens need to be read before writing a target token when using the autoregressive LLM at inference for simultaneous translation, wherein the selected attentions identify tokens in the input vector that would not be available for predicting target tokens when using the autoregressive LLM at inference for simultaneous translation from the source sequence to the target sequence according to the read-write decision policy.

Certain aspects of the disclosure concern a computer-implemented method for fine-tuning an autoregressive large LLM for simultaneous translation. The method includes: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: obtaining a plurality of queries and a plurality of keys respectively corresponding to the plurality of tokens in the input vector; generating an L×L attention matrix, wherein L represents a dimension of the input vector, wherein the attention matrix comprises attentions calculated as dot products of the plurality of queries and the plurality of keys; and applying an attention mask to the attention matrix, wherein the attention mask is configured to mask selected attentions from the attention matrix based on a read-write decision policy, wherein the read-write decision policy specifies how many source tokens need to be read before writing a target token when using the autoregressive LLM at inference for simultaneous translation, wherein the selected attentions identify tokens in the input vector that would not be available for predicting target tokens when using the autoregressive LLM at inference for simultaneous translation from the source sequence to the target sequence according to the read-write decision policy.

Certain aspects of the disclosure concern one or more non-transitory computer-readable media having encoded thereon computer-executable instructions causing one or more processors to perform a method for fine-tuning an autoregressive LLM for simultaneous translation. The method includes: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on self-attention mechanism, comprising: obtaining a plurality of queries and a plurality of keys respectively corresponding to the plurality of tokens in the input vector; generating an L×L attention matrix, wherein L represents a dimension of the input vector, wherein the attention matrix comprises attentions calculated as dot products of the plurality of queries and the plurality of keys; and applying an attention mask to the attention matrix, wherein the attention mask is configured to mask selected attentions from the attention matrix based on a read-write decision policy, wherein the read-write decision policy specifies how many source tokens need to be read before writing a target token when using the autoregressive LLM at inference for simultaneous translation, wherein the selected attentions identify tokens in the input vector that would not be available for predicting target tokens when using the autoregressive LLM at inference for simultaneous translation from the source sequence to the target sequence according to the read-write decision policy.

Certain aspects of the disclosure concern a computing system for fine-tuning an autoregressive LLM for simultaneous translation. The computing system includes: memory; one or more hardware processors coupled to the memory; and one or more non-transitory computer readable storage media storing instructions that, when loaded into the memory, cause the one or more hardware processors to perform operations comprising: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: generating an attention matrix comprising attentions obtained based on a plurality of queries and a plurality of keys derived from the input vector; applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and applying biases to attentions in the attention mask corresponding to no-mask indicators in the attention mask, wherein for each row of the attention matrix, the biases that are applied to attentions corresponding to no-mask indicators exhibits a linear increase from left to right.

Certain aspects of the disclosure concern a computer-implemented method for fine-tuning an autoregressive LLM for simultaneous translation. The method includes: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: generating an attention matrix comprising attentions obtained based on a plurality of queries and a plurality of keys derived from the input vector; applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and applying biases to attentions in the attention mask corresponding to no-mask indicators in the attention mask, wherein for each row of the attention matrix, the biases that are applied to attentions corresponding to no-mask indicators exhibits a linear increase from left to right.

Certain aspects of the disclosure concern one or more non-transitory computer-readable media having encoded thereon computer-executable instructions causing one or more processors to perform a method for fine-tuning an autoregressive LLM for simultaneous translation. The method includes: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: generating an attention matrix comprising attentions obtained based on a plurality of queries and a plurality of keys derived from the input vector; applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and applying biases to attentions in the attention mask corresponding to no-mask indicators in the attention mask, wherein for each row of the attention matrix, the biases that are applied to attentions corresponding to no-mask indicators exhibits a linear increase from left to right.

The foregoing and other features and advantages of the disclosed technologies will become more apparent from the following detailed description, which proceeds with reference to the accompanying figures.

### BRIEF DESCRIPTION OF THE DRAWINGS

FIG. 1 is an overall block diagram of an example computing system for fine-tuning an autoregressive LLM for simultaneous translation.

FIG. 2 is a block diagram of an example transformer model.

FIG. 3 is a block diagram of an example self-attention mechanism that can be implemented in the transformer of FIG. 2.

FIG. 4 depicts an example multi-head attention mechanism.

FIG. 5 depicts an example attention mask that can be used in a transformer model.

FIG. 6A depicts example inference attention connections for a first prediction step of the wait-1 policy.

FIG. 6B depicts example fine-tuning inference mirrored attention connections for the first prediction step of the wait-1 policy.

FIG. 7A depicts example inference attention connections for a second prediction step of the wait-1 policy.

FIG. 7B depicts example fine-tuning inference mirrored attention connections for the second prediction step of the wait-1 policy.

FIG. 8A depicts example inference attention connections for a third prediction step of the wait-1 policy.

FIG. 8B depicts example fine-tuning inference mirrored attention connections for the third prediction step of the wait-1 policy.

FIG. 9 depicts an attention mask for modeling simultaneous translation during fine-tuning, according to one example.

FIG. 10 depicts an attention mask for modeling simultaneous translation during fine-tuning, according to another example.

FIG. 11 depicts an attention mask for modeling simultaneous translation during fine-tuning, according to yet another example.

FIG. 12A depicts original biases applied to an example attention mask.

FIG. 12B depicts modified biases applied to the attention mask of FIG. 12A.

FIG. 13 is a flowchart illustrating an example method for fine-tuning an autoregressive LLM for simultaneous translation.

FIG. 14 is a flowchart illustrating another example method for fine-tuning an autoregressive LLM for simultaneous translation.

FIG. 15 depicts example fine-tuning hyperparameters used in an experimental study.

FIG. 16 depicts example experimental results evaluating quality of English-Dutch translation at different latencies.

FIG. 17 depicts example experimental results evaluating quality of English-Italian translation at different latencies.

FIG. 18 depicts example experimental results evaluating quality of English-French translation at different latencies.

FIG. 19 depicts example experimental results evaluating quality of English-German translation at different latencies.

FIG. 20 depicts example experimental results evaluating quality of English-Romanian translation at different latencies.

FIG. 21A depicts examples experimental results evaluating time to complete one epoch for different fine-tuning approaches.

FIG. 21B depicts examples experimental results evaluating computational cost of different approaches during inference.

FIG. 21C depicts example experimental results evaluating the distribution of sequence lengths.

FIG. 21D depicts example experimental results evaluating computational cost.

FIG. 22 is a block diagram of another example computing system in which described embodiments can be implemented.

FIG. 23 is a block diagram of an example cloud computing environment that can be used in conjunction with the technologies described herein.

### DETAILED DESCRIPTION

Described herein are systems and methods for fine-tuning LLMs for simultaneous translation. Specifically, a technique using attention mask, terms SimulMask, is disclosed herein which models simultaneous translation during fine-tuning by masking attention connections in accordance with a desired decision policy. In applying SimulMask, fine-tuning an LLM for simultaneous translation in a computational efficient manner can be achieved.

### Example Overview of Simultaneous Translation

Simultaneous machine translation (SimulMT), or simply “simultaneous translation,” is a dynamic process that produces a target language translation in real-time as the source language input is received. This technique is particularly critical in scenarios demanding immediate multilingual communication, such as international conferences, live broadcasts, and collaborative platforms. Unlike conventional machine translation, which processes entire input sequences before generating output, SimulMT necessitates concurrent processing and generation, posing unique challenges in latency, accuracy, and computational efficiency. These challenges are amplified by the need for models to make translation decisions based on partial and incrementally available source information.

Recent advancements in SimulMT have largely focused on adapting end-to-end transformer-based architectures. While these models have achieved notable successes, they often face difficulties in balancing computational efficiency with translation fidelity, particularly under the stringent requirements of real-time processing. More recently, LLMs have emerged as promising candidates for SimulMT, leveraging fine-tuning and specialized inference techniques. Fine-tuning involves adapting a pre-trained LLM to the specific task by updating its parameters using task-specific training data. In our case, for simultaneous translation, this process enables the model to learn policies for incremental input processing and real-time decision-making, tailoring its capabilities to the unique demands of SimulMT while preserving its general linguistic knowledge. However, the increased computational demands associated with managing and updating the key-value (KV) cache during target sequence generation pose significant limitations, especially when frequent cache dumps are required. Additionally, the absence of a universal simultaneous translation fine-tuning methodology that avoids the inefficiencies of data augmentation or excessive prompt restructuring further hampers the scalability and practicality of these approaches, leading to trade-offs between computational efficiency and translation performance.

The technologies described herein address many of the challenges noted above by introducing a novel attention mask called SimulMask, which represents a novel paradigm for fine-tuning LLMs for simultaneous translation. SimulMask employs an innovative attention mask that redistributes attention under a desired decision policy, effectively modeling simultaneous translation during fine-tuning. This approach is compatible with both flexible and fixed decision policies, providing a versatile foundation for further advancements. Additionally, by avoiding the injection of positional information into keys and values through a novel biasing mechanism, SimulMask enables efficient KV caching during SimulMT without compromising accuracy, significantly enhancing computational efficiency and translation performance.

### Example Computing System for Fine-Tuning LLMs for Simultaneous Translation

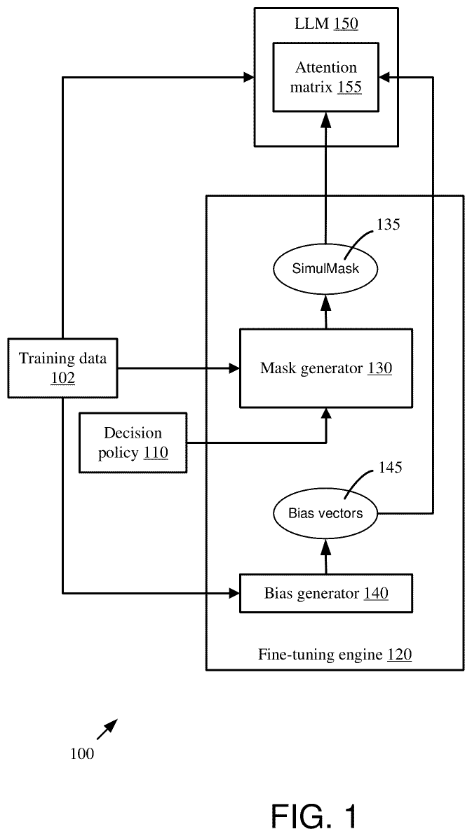

FIG. 1 shows an overall block diagram of an example computing system 100 for fine-tuning an autoregressive LLM 150 for simultaneous translation using a fine-tuning engine 120, according to the technologies disclosed herein. In some examples, the LLM 150 can be deployed locally on the computing system 100. In other examples, the LLM 150 can be hosted externally (e.g., on a third-party platform).

The LLM 150 can be fine-tuned using training data 102 to adapt its pre-trained parameters for the specific task of simultaneous translation. Fine-tuning involves adjusting the model's weights by exposing it to task-specific examples in the training data 102, allowing it to learn the nuances of real-time translation, such as processing partial source inputs and generating accurate target outputs concurrently. The fine-tuning process often employs optimization techniques, such as gradient descent, applied to minimize the difference between the model's predictions and the desired outputs.

The training data 102 used for fine-tuning can be represented as input vectors (also referred to as input sequences), each comprising a plurality of tokens organized into specific segments. Each input vector includes one or more source tokens representing a source sequence, a prompt following the source tokens, and one or more target tokens representing the target sequence translated from the source sequence. As described herein, tokens in the input vectors (e.g., source tokens and target tokens) can be words or parts of words. In some examples, the input vector can include a primary prompt before the source tokens, and the prompt between the source tokens and target tokens can be referred to as a secondary prompt. For example, an input vector could be structured as: “Translate the following sentence from English to German: s₁, s₂, . . . , sᵢ [a]: t₁, t₂, . . . , tᵢ”. In this case, the primary prompt, “Translate the following sentence from English to German:”, provides general instructions for the translation task, while the secondary prompt is a predefined separator ‘[a]:’ marking the transition between the source tokens (s₁, s₂, . . . , sᵢ) and the target tokens (t₁, t₂, . . . , tᵢ). This structured arrangement ensures that the LLM 150 can interpret the contextual relationships between source and target tokens effectively. In some examples, the primary prompt can be optional.

The LLM 150 can be an autoregressive LLM designed to process and generate sequences of tokens, leveraging a self-attention mechanism (e.g., a self-attention neural network) to capture contextual relationships between tokens within a sequence. The self-attention mechanism, as described further below, allows the LLM 150 to weigh the relevance of each token in the input sequence relative to others, enabling it to focus on the most important parts of the sequence when generating translations. The self-attention mechanism can maintain an attention matrix 155, which quantifies token relationships by assigning attention scores (or simply “attentions”) to pairs of tokens. These attention scores determine the contribution of each token to the overall context for a given position in the input sequence. The attention matrix 155 can be dynamically computed during both training and inference and plays an important role in the model's ability to handle partial source sequences and produce accurate, context-aware target sequences in real-time.

As shown in FIG. 1, the fine-tuning engine 120 can include a mask generator 130 configured to generate an attention mask, SimulMask 135, based on the training data 102 and a specific decision policy 110. The decision policy 110, also referred to as a read-write decision policy, dictates how the LLM 150 attends to the source and target tokens in the input vectors during training. In doing so, the decision policy defines how many tokens from the source sequence are available before predicting the next target token, conditioning the model's predictions on a fixed number of previous tokens.

The fine-tuning engine 120 can apply the SimulMask 135 to the attention matrix 155 of the LLM 150. As a result, the SimulMask 135 can restrict certain attention patterns in the attention matrix 155 according to the chosen decision policy 110, ensuring that tokens that would not be accessible during inference (due to the autoregressive nature of the model) are masked. For instance, under a chosen decision policy, the LLM 150 may only have access to a portion of the source tokens when generating a target token, and the attention mask prevents the LLM 150 from attending to tokens that would not be visible in a real-world translation scenario. In other words, the SimulMask 135 can mimic the behavior of the LLM 150 during inference, ensuring consistency between fine-tuning and actual translation tasks.

In some examples, the fine-tuning engine 120 also includes a bias generator 140. The bias generator 140 can be configured to generate bias vectors 145 that can be applied to the attention matrix 155 to further adjust the model's attention behavior and eliminate positional confusion in KV caching, as occurred in some existing fine-tuning approaches.

Further details on the generation of SimulMask 135, the bias vectors 145, and their application to the attention matrix 155, are described more fully below.

The described computing system 100 can be networked via wired or wireless network connections, including the Internet. Alternatively, the computing system 100 can be connected through an intranet connection.

The systems 100 and any of the other systems described herein can be implemented in conjunction with any of the hardware components described herein, such as the computing systems described below (e.g., processing units, memory, and the like). In any of the examples herein, training data, decision policies, attention matrices, attention masks, bias vectors, and the like can be stored in one or more computer-readable storage media or computer-readable storage devices. The technologies described herein can be generic to the specifics of operating systems or hardware and can be applied in any variety of environments to take advantage of the described features.

### Example Architecture of Transformer Models

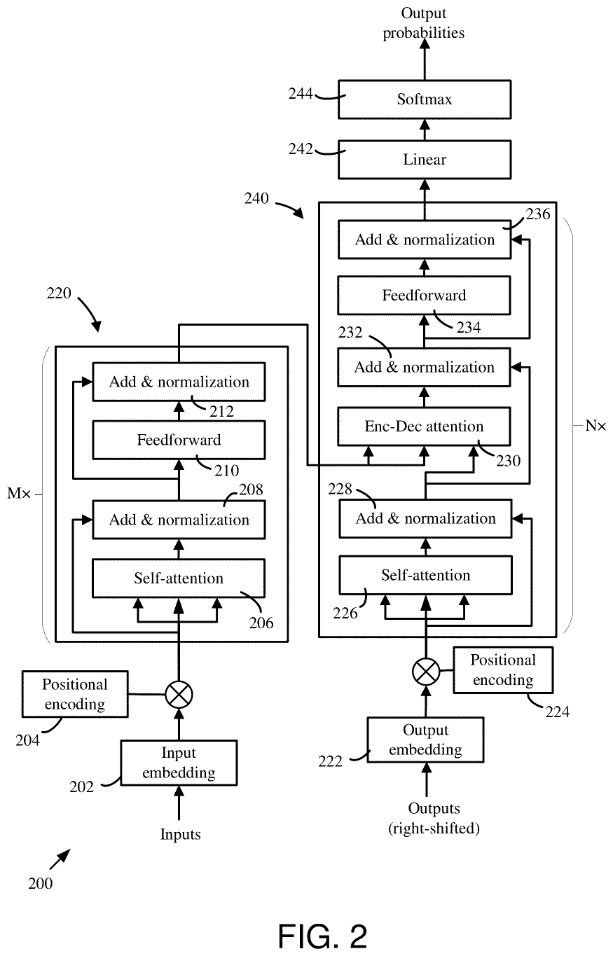

FIG. 2 shows an example architecture of a transformer 200, which can be used for simultaneous machine translation.

In the depicted example, the transformer 200 uses an autoregressive model to generate text content by predicting the next token in a sequence given the previous tokens. The transformer 200 can be pre-trained using maximum likelihood estimation to predict each token in the training dataset, given its context. Tokens are the smallest units of text processed by the transformer 200, which can be as short as a single character or as long as part of a word, one word, or multiple words.

As shown in FIG. 2, the transformer 200 can include an encoder 220 and a decoder 240. The encoder 220 processes input text, transforming it into a context-rich representation. The decoder 240 takes this representation and generates text output.

For autoregressive text generation, the transformer 200 generates text in order, relying on preceding tokens for context. During training, the target sequence can be presented to the decoder, right shifted by one position compared to the generated output. This allows the model to predict the next token based on previous tokens.

Text inputs to the encoder 220 represented as tokens can be preprocessed through an input embedding unit 202, which maps each token to a fixed-length vector. Similarly, output sequences can be preprocessed through an output embedding unit 222.

Generally, the vocabulary in transformer 200 is fixed and can be derived from a tokenizer.

In some examples, positional encodings (e.g., 204 and 224) can be added to the input and output embeddings to provide sequential order information. This allows the model to understand the relative positions of tokens in a sentence.

Both the encoder 220 and decoder 240 can include multiple stacked layers (resp. denoted by M× and N× in FIG. 2). The number of layers can vary depending on the specific architecture. Generally, a higher “M” or “N” typically means a deeper model, which can capture more complex patterns and dependencies in the data but may require more computational resources for training and inference. The number of stacked layers in the encoder 220 (M) can be the same as, or different from, the number of stacked layers in the decoder 240 (N).

Both the encoder 220 and decoder 240 can include multiple layers of attention and feedforward neural networks. An attention mechanism calculates the relevance of different words or tokens within an input sequence, enabling the model to focus on contextually relevant information. A feedforward neural network processes and transforms this information, applying non-linear transformations to the embeddings.

In the example depicted in FIG. 2, the encoder 220 includes a self-attention neural network 206 and a feedforward neural network 210, while the decoder 240 includes a self-attention neural network 226 and a feedforward neural network 234. The self-attention neural networks 206, 226 allow the transformer 200 to weigh the importance of different words or tokens within the input sequence (encoder 220) or output sequence (decoder 240).

The decoder 240 also includes an encoder-decoder attention neural network 230, which receives input from the encoder 220. This allows the decoder 240 to focus on relevant parts of the input sequence while generating the output sequence. The output of the encoder 220 serves as a continuous representation of the input sequence, which the decoder 240 can use to improve contextual accuracy.

Attention neural networks (e.g., 206, 226, 230) can implement single-head or multi-head attention mechanisms. Single-head attention uses one set of attention weights, while multi-head attention uses multiple sets in parallel to capture different aspects of the input sequence. Multi-head attention may enhance the model's ability to understand complex contexts, leading to more accurate text generation.

Both the encoder 220 and the decoder 240 can include addition and normalization layers (e.g., 208, 212 in the encoder 220; 228, 232, 236 in the decoder 240). Residual connections add the output of a layer to its input, and normalization layers can stabilize the learning process by normalizing features.

A linear layer 242 at the output end of the decoder 240 can transform the output embeddings into the original input space. The output embeddings are forwarded to the linear layer 242, which maps them to a space where each dimension corresponds to a token in the vocabulary of the transformer 200.

The output of the linear layer 242 can be fed to a softmax layer 244, which transforms the logits into probabilities. These probabilities sum to 1, with each corresponding to the likelihood of a particular token being the next in the sequence. The token with the highest probability is typically selected as the next token in the generated text output.

In some examples, an LLM (e.g., ChatGPT of Open AI, or the like) can include only the decoder, without the encoder, thus it can also be referred to as decoder-only LLM. This configuration can be useful for tasks such as text generation, where the model generates text based on a given prompt. Without the encoder, the LLM relies solely on the decoder to generate text in an autoregressive manner. The encoder-decoder attention neural network (e.g., 230) is removed in this setup, and the LLM uses self-attention neural networks within the decoder to handle context.

### Example Self-Attention Mechanisms

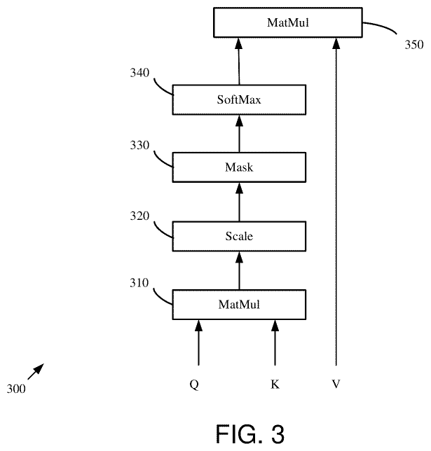

FIG. 3 illustrates an example self-attention mechanism 300 that can be implemented in the transformer of FIG. 2.

As shown, the self-attention mechanism 300 operates on queries (Q), keys (K), and values (V), which are matrices generated by applying learned linear transformations to the input sequence corresponding to each token in the input sequence. Each row in these matrices can represent a query, key, or value vector for a specific token. For example, a query vector represents the current token that needs to be encoded, a key vector represents a token in the input sequence, and a value vector represents the actual value of a token. The self-attention mechanism 300 computes attention scores (or “attentions”) between the query vector and all key vectors, and these scores can be used to weigh the contribution of each value vector to the output. This process can be performed for all query vectors in parallel.

The self-attention mechanism 300 includes a first matrix multiplication, or MatMul unit 310, which receives the query Q and key K as inputs. The first MatMul unit 310 is configured to perform a matrix multiplication operation between Q and the transpose of K, generating an attention matrix including attentions calculated as dot products of Q and K, measuring the similarity between the current token (represented by the query) and each other token (represented by the key).

The generated attention matrix can be passed to a scaling unit 320, which can scale the attention matrix by dividing each attention by a scaling factor, such as the square root of the dimensions of the queries and keys. This scaling can help stabilize the magnitudes of the dot products, preventing them from becoming too large.

The self-attention mechanism 300 can also include a masking unit 330, which can be used to prevent certain positions from attending to subsequent positions. Specifically, the masking unit 330 can be configured to apply an attention mask (e.g., the SimulMask 135 of FIG. 1) to the attention matrix. The attention mask can be constructed based on predefined constraints such as autoregressive requirements and a particular decision policy. This ensures that attention is focused only on tokens that would be accessible during inference.

The output of the masking unit 330 can be passed through a softmax activation layer 340. The softmax activation layer 340 is configured to apply a softmax function to the output of the masking unit 330, generating a distribution of attention weights. This ensures that the weights are positive and sum to one, so they can be interpreted as probabilities.

The self-attention mechanism 300 further includes a second MatMul unit 350 which receives the output of the softmax activation layer 340 and the input value V. The second MatMul unit 350 is configured to perform a matrix multiplication operation to generate the output of the self-attention mechanism 300, which is a weighted sum of the values, with the weights determined by the attention mechanism. The output of the self-attention mechanism 300 can be used for subsequent processing (e.g., as an input to the addition and normalization layers 208 or 228 of FIG. 2).

Mathematically, the output of the self-attention mechanism 300 can expressed by Equation (1) below:

$$A = softmax ( \frac{{QK}^{T} + M}{\sqrt{{d}_{h e a d}}} ) V \qquad ( 1 )$$

Here, M is an attention mask, and d_{head} represents the dimensionality of each attention head, which is used to scale the dot product of the Q and K vectors. For simultaneous translation, M desirably should model context limitations or time-based dependencies that might exist during inference but do not exist during training or fine-tuning. In conventional transformer architecture, M can be defined as a causal attention mask, where each entry, Mᵢⱼ, is represented by Equation (2) below to avoid attending to the future tokens.

$${M}_{ij} = \{ \begin{matrix}0 , & if j \leq i \\ - inf , & otherwise\end{matrix} . \qquad ( 2 )$$

Here, −inf is a predefined negative number (e.g., −1e³⁸ or the like) indicating negative infinity (−∞).

In some examples, KV caching can be used to optimize the self-attention mechanism 300 by leveraging a cache memory to store the key (K) and value (V) matrices corresponding to tokens in the input sequence. During processing, the K and V matrices for a selected token are retrieved from the cache memory, enabling efficient access to previously computed context. As new tokens are processed, updated K and V matrices are generated based on the token immediately following the selected one in the input sequence. These updated matrices are then stored back in the cache memory, ensuring the model has an up-to-date representation of the input context for subsequent attention calculations while avoiding redundant computations.

### Example Multi-Head Attention

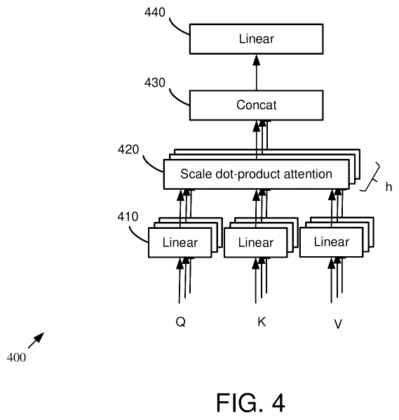

In some examples, the self-attention mechanism described above can be configured as a multi-head attention mechanism. Multi-head attention allows the encoder or decoder to capture different types of dependencies among events from multiple representation subspaces at different positions in the input sequence. This contrasts with the single-head attention mechanism which only captures dependencies from one representation subspace, potentially missing out on other important relationships among tokens. FIG. 4 illustrates an example of a multi-head attention mechanism 400.

The multi-head attention mechanism 400 includes three sets of linear activation layers 410 which respectively receive queries (Q), keys (K), and values (V). Each set of linear activation layers 410 can apply a learned linear transformation to its respective input, projecting them into different representation spaces. These transformed Q, K, and V are then passed to a set of scaled dot-product attention layers 420.

More specifically, the queries (Q), keys (K), and values (V) can be linearly projected h times with different, learned linear projections to dₖ, dₖ, and dᵥ dimensions, respectively, where dₖ refers to the dimension of the keys (K) and queries (Q), and dᵥ refers to the dimension of the values (V). These projections are performed h times, resulting in h different sets of queries (Q), keys (K), and values (V). Each set captures different aspects of the input data, allowing the model to attend to different features and relationships in the data.

Each of these attention layers 420 can be configured to apply the scaled dot-product attention mechanism (as described above with reference to FIG. 3) to the transformed Q, K, and V, generating a set of initial outputs. These initial outputs represent the attention outputs for each head in the multi-head attention mechanism 400. Each head can attend to different features in the input, thereby capturing different types of dependencies among tokens.

The initial outputs of the attention layers 420 can then be concatenated by a concatenator 430. This concatenation operation combines the outputs of the multiple attention heads into a single matrix, which captures a more comprehensive representation of the dependencies among tokens, as it includes information from multiple representation subspaces.

Finally, another linear activation layer 440 can apply a learned linear transformation to the concatenated output, generating the final output of the multi-head attention mechanism 400. This final output is a context-rich representation of the original input sequence, capturing information from different representation subspaces at different positions.

### Example Decision Policies

As described herein, read-write decision policies dictate how and when the LLM transitions between processing the source input (reading) and generating the translated output (writing). One example decision policy is the wait-k policy, which pauses translation until a predefined number of source tokens (k) have been processed. This approach allows the LLM to gather sufficient context from the source language before generating a target token, balancing the need for real-time translation with ensuring translation accuracy. In a wait-k policy, the LLM continues to “read” the source sequence until it has encountered a fixed number of source tokens, after which it begins to “write” the translated target tokens.

More advanced decision policies, such as those based on hidden states, can dynamically adjust when to “read” and “write” based on the LLM's internal understanding of the source sequence. The hidden states in the LLM reflect the model's comprehension of the current source sequence, providing a context-sensitive basis for making informed translation decisions. When the model's hidden state indicates sufficient understanding, the LLM can shift from reading to writing, translating the input sequence into the target sequence. This decision process can be adaptive, as it can respond to the complexity of the input, such as waiting longer for more ambiguous or complex parts of the source sequence before starting the translation.

### Example Self-Attention Masking in Transformer Models

In the context of SimulMT, the transformer model (such as the one depicted in FIG. 2) can incorporate specific masking strategies in both the encoder self-attention and decoder cross-attention mechanisms to adhere to predefined decision policies. For encoder self-attention, the model can enforce a causal structure by masking out future source tokens beyond the current decision boundary. This ensures that each source token only attends to itself and preceding tokens, complying with the constraints dictated by the decision policy.

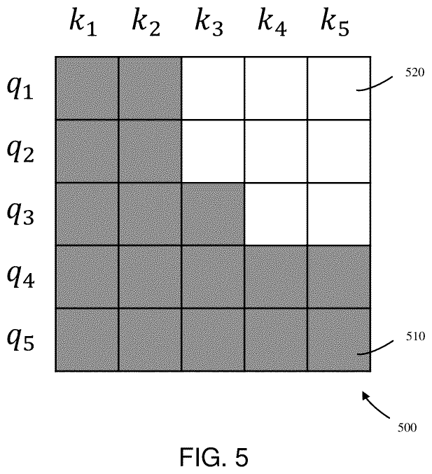

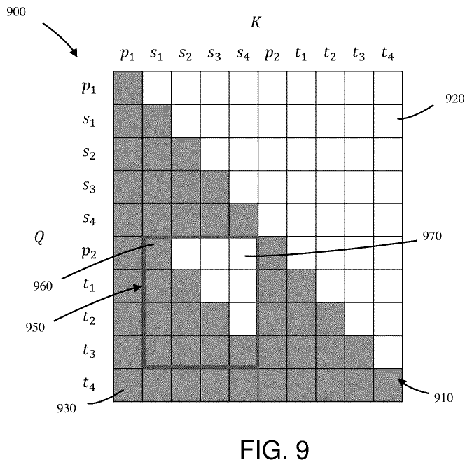

An example of such an attention mask 500 is illustrated in FIG. 5, where attention is selectively restricted based on the parameters of the decision policy to enforce sequential processing. In FIG. 5, as well as other illustrative figures (e.g., FIGS. 9-12B), the attention mask is depicted as an L×L matrix, where L represents the dimension of the input vector. Each row of the attention mask represents a query vector (Q), while each column corresponds to a key vector (K). The entries of the attention mask define permissible attention interactions. For example, an entry can be set to a mask indicator, represented by an unshaded entry (e.g., entry 510 in FIG. 5), which blocks attention. Or an entry can be set to a no-mask indicator, indicated by a shaded entry (e.g., entry 520 in FIG. 5), which allows attention. In some examples, the no-mask indicator can be zero, and the mask indicator can be −inf, which is a predefined negative number representing negative infinity for computing purposes.

In decoder cross-attention, masking is applied to prevent a target token from attending to source hidden states beyond the cumulative number defined by the decision policy function. This masking can be mathematically described by Equation (3):

$${M}_{tj} = \{ \begin{matrix}0 , & if j \leq f ( t ) \\ - inf , & otherwise\end{matrix} . \qquad ( 3 )$$

Here, f(t) is a function defining the read-write decision policy and denotes a cumulative number of source tokens to read when predicting a target token t, and Mₜⱼ represents the decoder cross-attention mask for target token t and source hidden state j.

Due to their deep understanding of linguistic structures and semantics, LLMs have demonstrated good performance in neural machine translation. This capability makes LLMs well-suited for SimulMT, enabling effective handling of complex contextual challenges during real-time translation. However, traditional approaches such as Equation (3), which models SimulMT for transformer-based decoders, are ineffective for decoder-only LLMs. This limitation arises because Equation (3) is designed specifically for cross-attention, where keys (K) are derived exclusively from the source sequence and queries (Q) from the target sequence. In decoder-only LLMs, self-attention is performed on a combined sequence of the prompt, source, and target, making it challenging to properly mask the source from the target and enforce autoregressive language modeling behavior. This inadequacy has led to the development of alternative methods for modeling SimulMT in LLMs, focusing on optimizing prompts to ensure accurate and context-aware translation decisions while adhering to autoregressive principles.

### Example Prompting Optimization Methods for Simultaneous Translation

Existing methods for fine-tuning LLMs for SimulMT primarily focus on prompting optimization. This approach involves techniques such as data augmentation to enhance the effectiveness of prompts or redefining prompt structures to better emulate the behavior of simultaneous translation.

### Data Augmentation Approach

Prompting optimization through data augmentation involves subdividing sentences in a dataset into partial sentence pairs, simulating the behavior of SimulMT where outputs are generated with incomplete input. This method, which can also be referred to as prefix fine-tuning, generates training samples by progressively adding one word at a time to both the source and target sequences until the end of the sequence is reached. For example, starting with a source-target sentence pair, the new dataset may consist of sentence pairs with increasingly larger prefixes of the source and target, enabling the model to learn translation dynamics for partial inputs. During fine-tuning, the model predicts only the final target word in each sequence, ensuring a focus on incremental translation.

An alternative approach to data augmentation involves randomly sampling sentence pairs from the dataset and truncating the source sentence to varying lengths, typically between 20% and 80% of the full sentence length. The corresponding target translations for these truncated inputs are then generated, often using an LLM such as ChatGPT. These truncated source-target sentence pairs are added to the original dataset, effectively expanding it and enabling the model to handle a broader range of partial input scenarios.

### Prompt Restructuring Approach

Prompting optimization through structural modifications involves embedding the decision policy directly into the prompt. One approach adopts a conversational prompting structure, where the source and target sequences alternate within the prompt, separated by delimiting tokens. For example, a source sequence S=[s₁, s₂, . . . , sₙ] and a target sequence T=[t₁, t₂, . . . , tₙ] could be expanded into a prompt like: “<s>, [U], s₁, s₂, [A], t₁, t₂, </s>, . . . , <s>, [U], sₙ, [U], [A], tₘ, </s>,” where the added <s>, </s>, [A], [U] are delimiting tokens. During fine-tuning, the choice of alternating subsequences is arrived at by attempting to maximize the relevant source context before each target sequence in the form of an oracle decision policy, which assumes ideal knowledge of which source tokens must be read to generate specific target tokens. For instance, the prompt can ensure an arbitrary target verb prediction only after the respective source verb is read. Minor perturbations to this policy can enhance generalizability, while inference uses a prompt constructor to deliver source sequences in fixed-size chunks.

Another method enhances prompting by combining structural changes with prefix fine-tuning. It aligns words in the source and target sequences to mimic an oracle decision policy but uses padding tokens to enforce alignment in the target sequence. The fine-tuning process generates prompts by subdividing aligned sentence pairs into partial source-target pairs, expanding the dataset. At inference, the model integrates the decision policy to output padding tokens when additional source context is required before generating target tokens. This structured approach can ensure causal alignment and enables the LLM to dynamically adjust based on available source context.

### Example Challenges of Prompting Optimization Methods

Prompting optimization, while working to a certain degree, is inherently deficient, possessing a host of fine-tuning and inference issues. These issues include a persistent fine-tuning −inference mismatch, consistent positional confusion in the target sequence, and high computational costs.

### Mismatch Between Fine-Tuning and Inference

A fine-tuning −inference mismatch occurs when the conditions during an LLM's fine-tuning differ significantly from its deployment environment. For example, fine-tuning a model for neural machine translation with full sentence availability but deploying it for SimulMT, where only partial input is accessible at the start of generation, leads to a substantial mismatch at inference. Additionally, the fine-tuning process must account for KV caching—a method of storing keys and values during inference to avoid redundant computations. The primary goal of fine-tuning for SimulMT is to minimize this mismatch and align the model's training and inference behaviors.

Prefix fine-tuning poses challenges for achieving high-quality SimulMT with KV caching because the continuously growing prompt size causes keys and values in the KV cache to diverge from those used during fine-tuning. For example, during SimulMT with a wait-1 policy, the prompt structure might look like: “Translate the following sentence: s₁, s₂, . . . , sᵢ₊₁ [a]: t₁, t₂, . . . , tᵢ.” In this example, the sentence “Translate the following sentence” can be referred to as a primary prompt and the separator token “[a]:” can be referred to as a secondary prompt. At the current write step, the query for tᵢ attends to the KV cache for “[a]:, t₁, t₂, . . . , tᵢ₋₁.” By construction, each key and value in the KV cache was generated in a previous time step with a different subset of the source sequence “s₁, s₂, . . . , sᵢ.” For instance, the keys and values for delimiting token “[a]:” when it predicted t₁ were conditioned only on s₁, whereas the keys and values for tᵢ₋₁ when it predicted tᵢ were conditioned on “s₁, s₂, . . . , sᵢ.” However, during prefix fine-tuning, the LLM was fine-tuned to predict tᵢ₊₁ as if the KV cache for “[a]: t₁, t₂, . . . , tᵢ” were each generated with the same subset of the source sequence “s₁, s₂, . . . , sᵢ.” Such fine-tuning −inference mismatch is unsolved through conventional prompting structures.

Prompt restructuring introduces additional mismatches during fine-tuning and inference. Fine-tuning methods often rely on an oracle decision policy, which assumes ideal knowledge of the source context. However, this oracle decision policy is not achievable during inference, creating discrepancies. Furthermore, LLMs that were fine-tuned with a specific oracle decision policy cannot be easily adaptable to other decision policies at inference without introducing further mismatches.

### Positional Confusion

Positional confusion during inference occurs when outdated positional information is retained in either the keys or values. This issue is prevalent in most SimulMT LLMs that utilize KV caching. The problem arises because, as the source sequence grows during SimulMT, the target sequence shifts correspondingly, requiring the positional information of the target sequence to be updated accordingly. However, due to the use of KV caching, the positional information stored in the keys and values is not properly updated, leading to inconsistencies that cause positional confusion.

For example, consider the sequence portion “[a]: t₁, t₂, . . . , tᵢ.” After the first prediction step, the positional distances between s₁ and “[a]:” and between s₁ and t₁ would initially be 1 and 2, respectively. Following the next read, where the source sequence becomes s₁, s₂, these distances should update to 2 and 3, respectively. However, with KV caching, the positional distances remain fixed at 1 and 2 in the stored keys and values, creating positional confusion. As translation continues, the gap between the actual positional distances and the outdated ones in the KV cache widens. Addressing this issue is important to mitigating LLM hallucinations and maintaining the accuracy of translations.

### Computational Cost

Avoiding KV caching and instead recomputing all the keys and values at each prediction step is the default solution for resolving the fine-tuning −inference mismatch and positional confusion problems when using prefix fine-tuning. While effective in maintaining translation quality, this approach can significantly increase computational costs, making it less suitable for streaming tasks like SimulMT, where latency is critical.

Beyond KV caching, prefix fine-tuning methods are computationally expensive due to the expansion of the dataset. Subdividing each sample into multiple segments can drastically increase the dataset size, resulting in a significant rise in the time required to complete each epoch. This increase in computational burden is not accompanied by the addition of new information, unlike standard data augmentation techniques. Consequently, many implementations are forced to fine-tune with only a subset of their full prefix datasets to mitigate costs.

Prompt restructuring methods also introduce computational challenges. For instance, adding delimiting tokens in the prompt sequence or padding tokens to align source and target sequences expands the sequence length. Since the computational cost of self-attention in LLMs scales quadratically with sequence length, these methods increase the resource demands for both inference and fine-tuning. Currently, no existing fine-tuning techniques can properly balance computational efficiency with high-quality translation and low latency.

### Example Inference-Mirrored Attention for Simultaneous Translation

The SimulMask technology disclosed herein provides a paradigm shift in fine-tuning LLMs for simultaneous translation that eschews current methods of prompting optimization. Through SimulMask, which restricts attention connections during fine-tuning, the fine-tuning −inference mismatch and positional confusion problems described above can be efficiently solved. In the approach described below, SimulMask is applied to the wait-k decision policy as an example. However, it should be understood that the choice of wait-k is just one example of many decision policies that may have been chosen.

### Inference Mirrored Attention

Under simultaneous translation, the latest translation token at each prediction step is conditioned only on the running source tokens. For conventional transformers, specialized attention masks could achieve such conditioning. However, directly mapping these to LLMs is not feasible because they fail to enforce autoregressive language modeling and cannot mask properly when the prompt, source, and target sequences are collectively included in the queries and keys. As such, prior work attempted to achieve such conditioning during fine-tuning using various prompting optimization methods, which are associated with many shortcomings as described above. According to the technologies disclosed herein, inference mirrored attention can be used to model SimulMT with attention masks for LLMs by mirroring the attention during inference at fine-tuning according to any chosen decision policy.

For example, consider the input sequence “p₁, s₁, s₂, s₃, s₄, p₂, t₁, t₂, t₃, t₄,” where s₁, s₂, s₃, s₄ represent a four-word source sequence, t₁, t₂, t₃, t₄ represent a four-word target sequence, and p₁ and p₂ are prompting regions. In this example, p₁ can be a primary prompt and p₂ can be a secondary prompt. In some examples, the primary prompt can include multiple prompt tokens, and p₁ in this input sequence can represent the last prompt token before the first source token s₁ (other prompt tokens in the primary prompt before p₁ can be omitted). The secondary prompt can also have multiple prompt tokens. In the depicted example, it is assumed that the secondary prompt includes a single prompt token p₂ immediately preceding the first target token t₁.

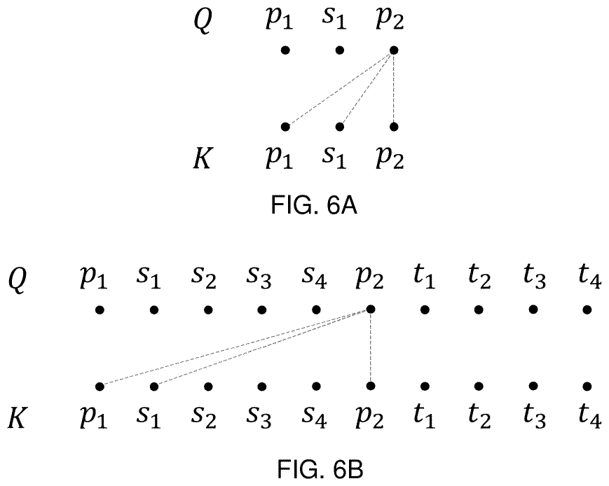

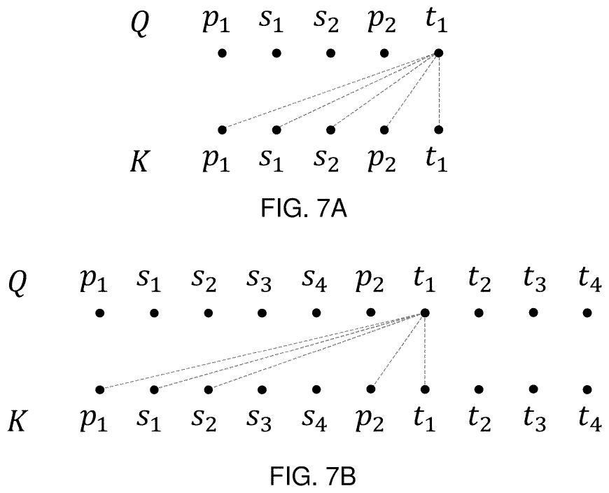

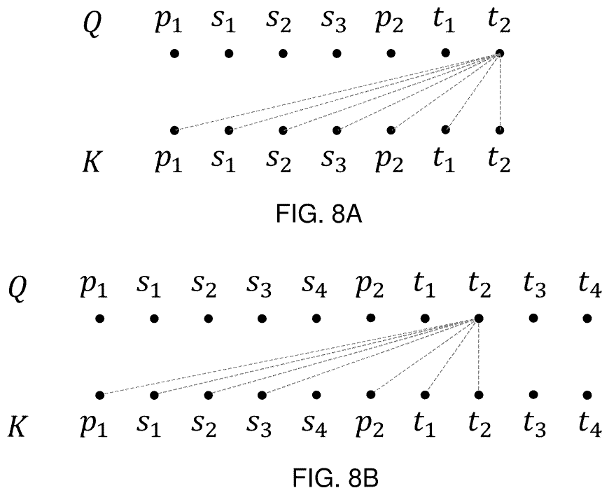

At inference, by definition of the wait-1 policy, p₂ predicts t₁ and is conditioned on the partial sequence p₁, s₁, p₂. As such, as shown in FIG. 6A, the query of p₂ attends to the keys of p₁, s₁, p₂. To eliminate the fine-tuning −inference mismatch, fine-tuning should mirror this behavior by ensuring the query of p₂ attends to the same keys, as shown in FIG. 6B, rather than attending to the entire source sequence. For each successive prediction step, the previously predicted target word tᵢ predicts the next target word tᵢ₊₁ by conditioning on an additional source word sᵢ₊₁, acquired from the previous read step. Fine-tuning mimics this behavior by ensuring the query for tᵢ attends to the same keys as during its inference step. The attention connections for two subsequent prediction steps are illustrated in FIGS. 7A-7B and FIGS. 8A-8B, respectively.

Inducing Inference Mirrored Attention with SimulMask

As disclosed herein, an attention mask, also referred to as SimulMask, can be used to restrict attention during fine-tuning to mimic an arbitrary decision policy during simultaneous translation. An attention mask is preferable to prompting optimization as it is flexible and directly extends the LLM causal attention mask.

As an example, FIG. 9 shows an attention mask 900 which can be created for the wait-1 policy that extends the example described above with reference to FIGS. 6A-8B. Since the LLM is autoregressive, the attention mask 900 can be initialized as a causal attention mask from which attention is limited to be identical to the attention during simultaneous translation for the source sequence. The causal attention mask can be defined by Equation (2) so that all entries above the main diagonal (e.g., entry 920) are set to the mask indicator (e.g., −inf) and all entries on or below the main diagonal 910 (e.g., entry 930) are set to the no-mask indicator (e.g., 0). In this example, L=10 because the length of the input sequence is ten.

The causal attention mask can then be modified by selectively removing certain attentions (e.g., entry 970) by setting selected attentions to the mask indicator (e.g., −inf). For example, starting from the prompt p₂, from the example in FIG. 6B, p₂ generates the first target token, t₁, conditioned on “p₁, s₁, p₂.” As such, the attentions between p₂ and s₂, s₃, s₄ are eliminated (e.g., set to −inf) in the attention mask 900. Similarly, t₁ and t₂ are conditioned on “p₁, s₁, s₂, p₂, t₁,” and “p₁, s₁, s₂, s₃, p₂, t₁, t₂,” respectively. Thus, attentions can be eliminated (e.g., set to −inf) between t₁ and s₃, s₄, as well between t₂ and s₄ in the attention mask 900.

Since each decision policy performs read-write decisions differently, each limits attention differently and, subsequently, a different attention mask may be constructed for each sequence. The general procedure to construct an attention mask or SimulMask for a given decision policy can include the following steps:

First, a causal attention mask can be constructed that serves as the foundation for the SimulMask. This mask can be defined as an L×L matrix M, where L represents the dimension of the input vector. Entries of the matrix M represents the relationship between queries and keys and can be determined according to Equation (2). Specifically, an entry Mᵢⱼ can be assigned a no-mask indicator (e.g., 0) if the column index j is less than or equal to the row index i, allowing attention within causal boundaries. Otherwise, Mᵢⱼ (which is above the main diagonal 910 of the matrix M) can be assigned to a mask indicator (e.g., −inf) to disallow attention.

Next, the causal attention mask can be modified by setting selected entries below the main diagonal of the attention mask to the mask indicator (e.g., −inf).

In an exemplary implementation, a sub-matrix within the causal attention mask can be identified. The size of the sub-matrix can be set to S×T, where S and T denote the counts of source and target tokens, respectively. The position of this sub-matrix within the causal attention mask can be determined based on a query predicting a first target token and a key corresponding to a first source token. In the example depicted in FIG. 9, the dimension of the sub-matrix 950 is 4×4 because the lengths of the source sequence and the target sequence are both four. A top-left corner 960 of the sub-matrix 950 can be determined as the intersection between the query p₂ predicting the first target token t₁ and the key representing the first source token s₁. Alternatively, the sub-matrix can be identified in other ways, such as by determining a top-right corner, a bottom-left corner, or a bottom-right corner, based on the corresponding intersections of query-key pairs.

The identified sub-matrix can then be replaced with a sub-attention mask defined by an S×T matrix M′, wherein an entry, M′ₜⱼ, of the matrix M′ is determined by the Equation (3) above. In other words, each entry, M′ₜⱼ, of the matrix M′ is determined by a read-write decision policy function f(t), which specifies the cumulative number of source tokens to attend to when predicting a target token t. In the example depicted in FIG. 9, after applying the sub-attention mask, six entries (e.g., entry 970) located in the top-right corner region of the sub-matrix 950 are set to the mask indicator (e.g., −inf) according to the wait-1 decision policy.

In the example depicted in FIGS. 6A-8B, the secondary prompt which separates the source sequence from the target sequence is assumed to include only one token. Thus, FIG. 9 shows a single row corresponding to the query p₂ which predicts the first target token t₁. In other examples, the secondary prompt may include multiple tokens. For instance, the secondary prompt may include an end prompt token and one or more leading prompt tokens before the end prompt token, and the query predicting the first target token is derived from the end prompt token. In such circumstances, additional entries may be set to the mask indicator (e.g., −inf) after replacing the identified sub-matrix with the sub-attention mask. Specifically, one or more rows above the sub-matrix that correspond to the one or more leading prompt tokens can be identified. Then, entries from the top row of the sub-attention mask can be copied to the corresponding columns in these rows above the sub-matrix. By doing so, the hidden states associated with non-source queries (e.g., queries representing the leading prompt tokens) are restricted from retaining information about the entire source sequence, ensuring that later layers in the LLM remain consistent with the constraints imposed by the decision policy.

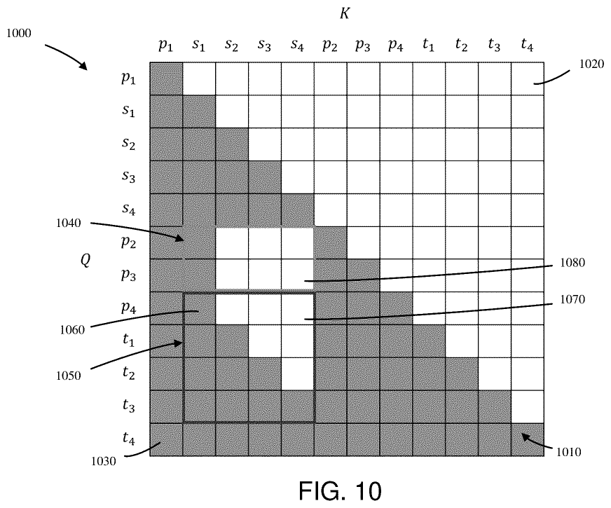

As an example, FIG. 10 shows an attention mask 1000 created for another input sequence “p₁, s₁, s₂, s₃, s₄, p₂, p₃, p₄, t₁, t₂, t₃, t₄,” still using the wait-1 decision policy. In this example, the secondary prompt is assumed to comprise three prompt tokens, including two leading prompt tokens (p₂, p₃) and one end prompt token (p₄). Thus, the attention mask 1000 has a dimension of 12×12, including three rows and three columns corresponding to these three prompt tokens.

Using the same process described above, the attention mask 1000 can be initialized as a causal attention mask where all entries above the main diagonal 1010 (e.g., entry 1020) are set to the mask indicator (e.g., −inf), while all remaining entries (e.g., entry 1030) are set to the no-mask indicator (e.g., 0). Then, a sub-matrix 1050 within the causal attention mask with the same size 4×4 can be determined, e.g., by locating a top-left corner 1060 of the sub-matrix 1050, which represents an intersection of the query p₄ (i.e., the query representing the end prompt token) predicting the first target token t₁ and the key representing the first source token s₁. This identified sub-matrix can be replaced by a sub-attention mask defined by a 4×4 matrix M′, whose entries are determined by the Equation (3). As a result, six entries (e.g., entry 1070) located in the top-right corner region of the sub-matrix 1050 are set to the mask indicator (e.g., −inf) according to the wait-1 decision policy. Finally, for the two rows 1040 immediately above the sub-matrix 1050, which correspond to the queries for the two leading prompt tokens (p₂, p₃), entries from the top row of the sub-attention mask can be copied to the corresponding columns (e.g., columns for s₁, s₂, s₃, and s₄), resulting in six additional entries (e.g., entry 1080) being set to the mask-indicator (e.g., −inf). As a result, the queries associated with the leading prompt tokens inherit the masking constraints of the sub-attention mask, preventing unintended attention to source tokens outside the scope defined by the decision policy.

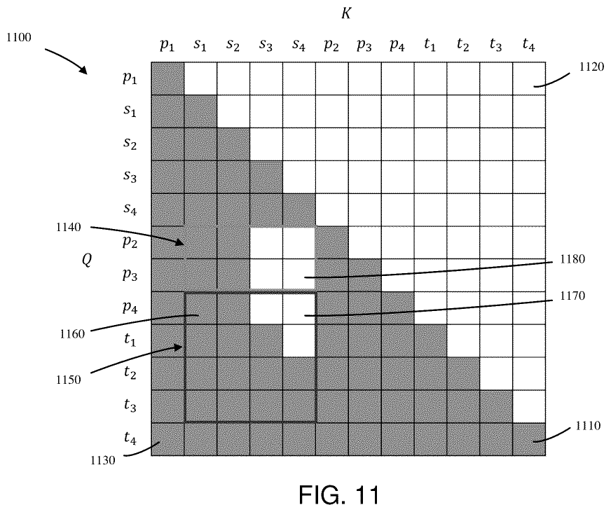

As another example, FIG. 11 shows an attention mask 1100 created for the same input sequence “p₁, s₁, s₂, s₃, s₄, p₂, p₃, p₄, t₁, t₂, t₃, t₄,” using a wait-2 decision policy instead. Similar to the construction of the attention mask 900, the attention mask 1100 is initialized as a causal attention mask where all entries above the main diagonal 1110 (e.g., entry 1120) are set to the mask indicator (e.g., −inf), while all remaining entries (e.g., entry 1130) are set to the no-mask indicator (e.g., 0). Next, a sub-matrix 1150 with the same size 4×4 is identified within the causal attention mask by locating its top-left corner 1160, which represents the intersection of the query p₄ (i.e., the end prompt token) predicting the first target token t₁ and the key corresponding to the first source token s₁. This sub-matrix 1150 can be replaced by a sub-attention mask defined by a 4×4 matrix M′, whose entries are determined by Equation (3). As a result, three entries (e.g., entry 1170) in the top-right corner region of the sub-matrix 1150 are set to the mask indicator (e.g., −inf) to satisfy the wait-2 decision policy. Finally, for the two rows 1140 immediately above the sub-matrix 1150, which correspond to the queries for the two leading prompt tokens (p₂, p₃), entries from the top row of the sub-attention mask are copied to the corresponding columns (e.g., columns for s₁, s₂, s₃, and s₄), causing four additional entries (e.g., entry 1180) being set to the mask indicator (e.g., −inf).

In the examples depicted in FIGS. 9, 10, and 11, all entries above and at least some entries below the main diagonal of the attention mask have a mask indicator (e.g., −inf), while all remaining entries of the attention mask have a no-mask indicator (e.g., 0). The presence of mask indicators below the main diagonal is influenced by the decision policies (e.g., wait-1, wait-2) applied during the construction of the sub-attention mask that replaces the sub-matrix within the causal attention mask. In some scenarios, however, it is possible for no entries below the main diagonal to contain a mask indicator. For example, if a wait-7 decision policy is applied to an input sequence of only 5 tokens, the constraints of the policy would inherently be satisfied without requiring additional masking below the main diagonal (e.g., the condition j≤f(t) is always true in Equation (3)).

The computation for constructing an attention mask using the above method is negligible compared with the computation of the LLM's forward and backward passes during fine-tuning. Since the attention mask is not applied during inference, it does not impact computational cost at deployment. Therefore, the attention mask disclosed herein provides an excellent option for mimicking simultaneous translation during fine-tuning and providing low-latency translations at inference.

### Example Positional Reordering

As described above, positional confusion during inference arises from retaining outdated positional information in either the keys or values. Addressing this issue requires providing positional information without injecting it directly into the sequence or KV cache. One example approach is using ALiBi (short for “attention with linear biases”) positional embedding, which supplies positional information through static biases (or simply “biases”) in attention. The bias can be applied to each query-key dot product row in the attention calculation, as shown in Equation (4), where m is a head-specific constant (e.g., in the multi-head attention mechanism 400 of FIG. 4, each head can apply a unique bias scaling factor m to its calculated attentions, allowing for distinct positional adjustments across heads):

$${q}_{i} {K}^{T} + {M}_{i} + m \cdot [ - ( i - 1 ) , … , - 1 , 0 ] \qquad ( 4 )$$

Thus, for a selected row of the attention matrix, the applied biases in a row can be represented by a bias vector m·[−(i−1), . . . , −1,0] whose values linearly increase from left to right, with a step size m.

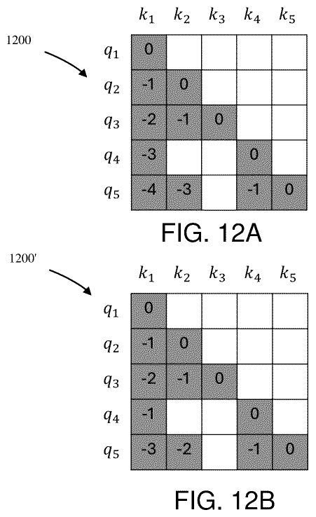

However, standard ALiBi model is not naturally compatible with SimulMask, as SimulMask removes attention between the target queries and source keys (e.g., by masking selected attentions below the main diagonal of the attention mask). This removed attention creates a gap in ALiBi biases during fine-tuning that is absent during inference. An example attention mask 1200 having such a gap is shown in FIG. 12A (m=1), where queries q₄ and q₅ exhibit gaps or discontinuities in the bias progression in positional distance. As shown, while the biases applied to queries q₂ and q₃ linearly increases from left to right (with step size of +1), the biases applied to the query q₄ jump from −3 in the first column to 0 in the fourth column due to two masked entries in the second and third columns. Likewise, the biases applied to the query q₅ jump from −3 in the first column to −1 in the fourth column due to the masked entry in the third column.

As described herein, a modified ALiBi can be deployed to eliminate the bias gap by adjusting the bias values of all query rows influenced by SimulMask. Specifically, for each query row of the attention mask, the bias values can be adjusted based on how many attentions are removed along the row (e.g., the number of entries in the row and below the main diagonal that are set to −inf) using SimulMask. More specifically, for each row of the attention matrix having one or more attentions to be masked by the sub-attention mask, the biases initialized using Equation (4) that are left of the one or more masked attentions can be offset based on the count of the one or more masked attentions in the row.

FIG. 12B illustrates an attention mask 1200′ modified from the attention mask 1200. As shown, in the case of q₄, which cannot attend to k₂ and k₃, the bias to the left of the gap is reduced by 2 (e.g., from −3 to −1). Similarly, for q₅, which cannot attend to k₃, the two biases to the left of the gap are reduced by 1 (e.g., from −4 to −3, and from −3 to −2, respectively). As a result, the applied biases linearly increase from left to right, skipping the gaps and treating them as if they do not exist, ensuring a consistent positional bias progression.

Thus, by integrating the modified ALiBi with SimulMask, positional confusion can be effectively eliminated from the LLM during simultaneous translation.

It should be noted that the bias vector defined in Equation (4) is merely exemplary, not exclusive. For example, the bias vector can also be defined as m·[0, 1, . . . , i−1], or other variations that adjust the positional biases based on alternative patterns or scaling factors tailored to specific model architectures or task requirements.

Additionally, it should be noted that the modified ALiBi is applied only during the fine-tuning phase to address the bias gaps introduced by SimulMask. During inference, the model reverts to the standard ALiBi computation.

### Example Overall Methods for Fine-Tuning an LLM for Simultaneous Translation

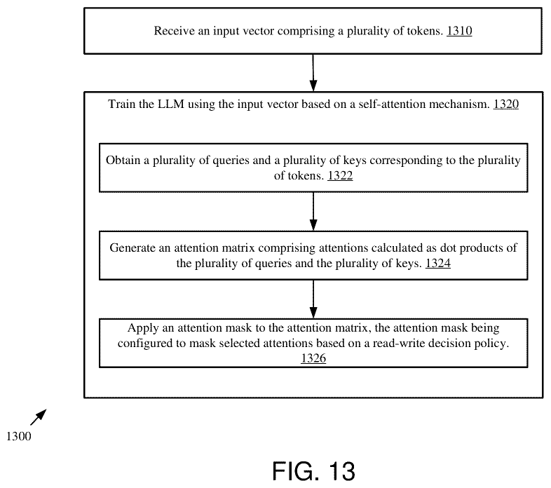

FIG. 13 is a flowchart describing an overall method 1300 for fine-tuning an autoregressive LLM for simultaneous translation. The method 1300 can be implemented by the fine-tuning engine 120 of FIG. 1.

At step 1310, the method 1300 can receive an input vector comprising a plurality of tokens. The plurality of tokens can include one or more source tokens, a prompt following the one or more source tokens, and one or more target tokens following the prompt. The one or more source tokens represent a source sequence, and the one or more target tokens represent a target sequence translated from the source sequence.

At step 1320, the method 1300 can train the autoregressive LLM using the input vector based on a self-attention mechanism. The training can include multiple sub-steps described below.

At step 1322, the method 1300 can obtain a plurality of queries and a plurality of keys respectively corresponding to the plurality of tokens in the input vector.

At step 1324, the method 1300 can generate an L×L attention matrix, where L represents a dimension of the input vector. The attention matrix includes attentions calculated as dot products of the plurality of queries and the plurality of keys.

Then, at step 1326, the method 1300 can apply an attention mask to the attention matrix. The attention mask can be configured to mask selected attentions from the attention matrix based on a read-write decision policy. The read-write decision policy specifies how many source tokens need to be read before writing a target token when using the autoregressive LLM at inference for simultaneous translation. The selected attentions identify tokens in the input vector that would not be available for predicting target tokens when using the autoregressive LLM at inference for simultaneous translation from the source sequence to the target sequence according to the read-write decision policy.

In some examples, the read-write decision policy is a wait-k decision policy, where k is an integer representing a count of source words that must be read before a target word can be generated when using the autoregressive LLM for simultaneous translation. Alternatively, the wait-k policy can be defined based on tokens, where k represents the number of source tokens that must be read before generating a target token.

In some examples, generating the attention mask includes constructing a causal attention mask defined by an L×L matrix M, wherein an entry, Mᵢⱼ, of the matrix M is determined by

$${M}_{ij} = \{ \begin{matrix}0 , & if j \leq i \\ - inf , & otherwise\end{matrix} ,$$

wherein −inf is a predefined negative number indicating negative infinity; and modifying the causal attention mask based on the read-write decision policy.

In some examples, modifying the causal attention mask includes identifying a sub-matrix within the causal attention mask. A position of the sub-matrix within the causal attention mask can be determined based on (a) a query predicting a first target token and (b) a key corresponding to a first source token.

In some examples, modifying the causal attention mask further includes replacing the sub-matrix of the causal attention mask with a sub-attention mask defined by an S×T matrix M′, wherein S is a count of the source tokens in the input vector and Tis a count of the target tokens in the input vector. An entry, M′ₜⱼ, of the matrix M′ can be determined by

$${M}_{tj}^{′} = \{ \begin{matrix}0 , & if j \leq f ( t ) \\ - inf , & otherwise\end{matrix} ,$$

wherein f(t) is a function defining the read-write decision policy and denotes a cumulative number of source tokens to read when predicting a target token t.

In some examples, the prompt can include an end prompt token and one or more leading prompt tokens before the end prompt token, and the query predicting the first target token corresponds to the end prompt token. Modifying the causal attention mask can further includes identifying one or more rows above the sub-matrix that correspond to the one or more leading prompt tokens, and copying entries from a top row of the sub-attention mask to corresponding columns in the one or more rows above the sub-matrix.

In some examples, training the autoregressive LLM further includes applying static biases to the attention matrix. For an i-th row of the attention matrix, the static biases can be initialized as a row vector whose values linearly increase from left to right.

In some examples, training the autoregressive LLM further includes adjusting the static biases. The adjusting includes for each row of the attention matrix having one or more attentions to be masked by the sub-attention mask, the static biases initialized for attentions that are left of the one or more masked attentions are offset based on a count of the one or more masked attentions in the row.

In some examples, training the autoregressive LLM further includes obtaining a plurality of values corresponding to the plurality of tokens in the input vector, calculating a plurality of attention weights based on the attention matrix and the attention mask, and determining a weighted sum of the plurality of values. The plurality of attention weights is respectively assigned to the plurality of values.

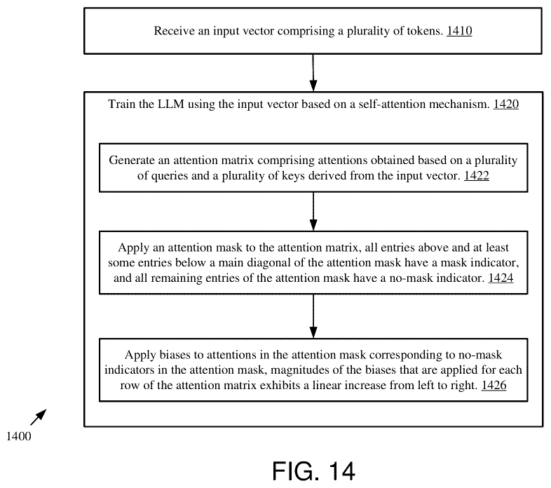

FIG. 14 is a flowchart describing another overall method 1400 for fine-tuning an autoregressive LLM for simultaneous translation. The method 1400 can be implemented by the fine-tuning engine 120 of FIG. 1.

At step 1410, the method 1400 can receive an input vector comprising a plurality of tokens. The plurality of tokens can include one or more source tokens, a prompt following the one or more source tokens, and one or more target tokens following the prompt. The one or more source tokens represent a source sequence, and the one or more target tokens represent a target sequence translated from the source sequence.

At step 1420, the method 1400 can train the autoregressive LLM using the input vector based on a self-attention mechanism. The training can include multiple sub-steps as described below.

At step 1422, the method 1400 can generate an attention matrix comprising attentions obtained based on a plurality of queries and a plurality of keys derived from the input vector.

At step 1424, the method 1400 can apply an attention mask to the attention matrix. All entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked.

Then, at step 1426, the method 1400 can apply biases to attentions in the attention mask corresponding to no-mask indicators in the attention mask. For each row of the attention matrix, the biases that are applied to attentions corresponding to no-mask indicators exhibits a linear increase from left to right.

In some examples, training the autoregressive LLM further includes generating the attention mask, including initializing the attention mask as a causal attention mask where all entries above the main diagonal are set to the mask indicator and all entries on or below the main diagonal are set to the no-mask indicator, and changing selected entries below the main diagonal from the no-mask indicator to the mask indicator according to a read-write decision policy. The read-write decision policy specifies how many source tokens need to be read before writing a target token when using the autoregressive LLM at inference for simultaneous translation.

In some examples, the changing includes identifying a sub-matrix within the causal attention mask. A position of the sub-matrix can be determined based on (a) a query predicting a first target token and (b) a key corresponding to a first source token.

In some examples, the changing can further include replacing the sub-matrix with a sub-attention mask. One or more entries at a top-right corner region of the sub-attention mask have the mask indicator while remaining entries of the sub-attention mask have the no-mask indicator.

In some examples, the changing can further include generating the sub-attention mask based on the read-write decision policy. The one or more entries at the top-right corner region of the sub-attention mask identifies tokens in the input vector that would not be available for predicting target tokens when using the autoregressive LLM at inference for simultaneous translation from the source sequence to the target sequence according to the read-write decision policy.

In some examples, the prompt includes an end prompt token and one or more leading prompt tokens before the end prompt token, and the query predicting the first target token is derived from the end prompt token. The changing can further include identifying one or more rows above the sub-matrix that correspond to the one or more leading prompt tokens, and copying entries from a top row of the sub-attention mask to corresponding columns in the one or more rows above the sub-matrix.

In some examples, the self-attention mechanism is configured to calculate a plurality of attention weights based on the attention matrix, the attention mask, and the biases, and determine a weighted sum of a plurality of values derived from the input vector. The plurality of attention weights is respectively assigned to the plurality of values.

In some examples, attentions in the attention matrix are calculated as dot products of the plurality of queries and the plurality of keys. Applying the attention mask includes adding the attention mask to the attention matrix. The mask indicator can be a predefined negative number indicating negative infinity, and the no-mask indicator can be zero.

In some examples, the self-attention mechanism includes a multi-head self-attention neural network. The biases applied in each head of the self-attention neural network are defined by a head-specific scale which determines a slope of the linear increase.

The methods 1300, 1400 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### EXAMPLE EXPERIMENTS

### Example Experimental Setup: Fine-Tuning

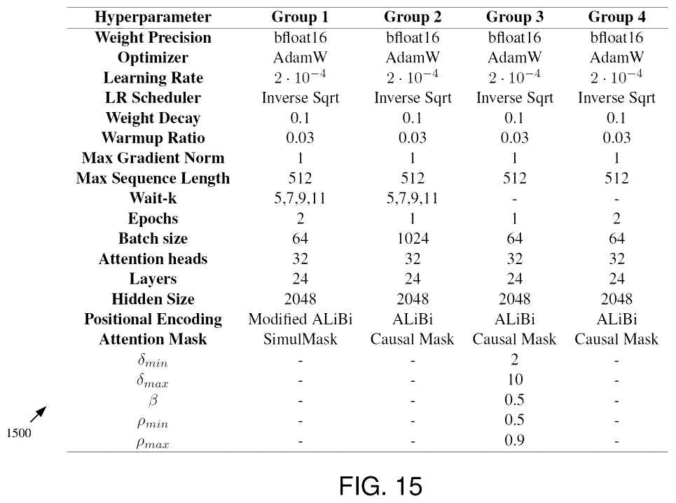

Experimental studies were conducted to evaluate the performance of various LLM-based fine-tuning techniques for simultaneous translation, using a 1.3 billion parameter Falcon model pre-trained on the RefinedWeb dataset. Seven different fine-tuning strategies were compared: (1) causal-offline, fine-tuned with a causal attention mask and evaluated it for non-simultaneous machine translation (non-simuMT); (2) causal-rec, fined-tuned with a causal attention mask with KV recomputing; (3) prefix-rec and prefix-norec, fine-tuned using prefix fine-tuning with and without KV recomputing, respectively; (4) converse-norec, fine-tuned with conversational prompting; and (5) SM-norec-mod and SM-norec, fined-tuned with SimulMask with and without modifying ALiBi, as described above. The fine-tuning hyperparameters for these approaches are summarized in table 1500 of FIG. 15.

The experiments were conducted using language pairs from the IWSLT 2017 dataset, specifically English-French (en-fr), English-Italian (en-it), English-Dutch (en-nl), English-Romanian (en-ro), and English-German (en-de). The prompts used for the SM-norec, causal-rec, causal-offline, prefix-rec, and prefix-norec models have the following format: “Translate the following sentence from [SRC] to [TGT]: [SRC-Sentence]\nAssistant: [TGT-Sentence] Implementation of converse-norec followed an approach described in Wang et al. “Conversational simulmt: Efficient simultaneous translation with large language models,” arXiv preprint arXiv: 2402.10552 (2024). However, Itermax method from the SimAlign toolkit was used leveraging XLM-ROBERTa base to align words due to reported better alignments compared to other alternatives.

### Example Experimental Setup: Evaluation Protocol

The translation quality and latency for SimulMT were evaluated using Simul-LLM inference agents integrated with the SimulEval toolkit. Translation quality was measured using detokenized BLEU scores computed with SacreBLEU, while latency was assessed using Length-Adaptive Average Lagging (LAAL). The computational cost of SimulMT was recorded in GFLOPs. All metrics were obtained using a single A10 GPU with bfloat16 precision. Models fine-tuned for the wait-k policy were evaluated at a wait-k four lower, corresponding to the setting for which they were fine-tuned.

### Example Experimental Results: Translation Quality and Latency Results

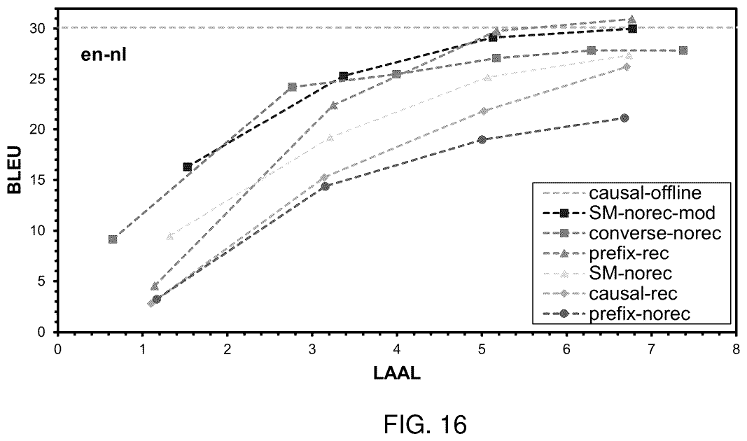

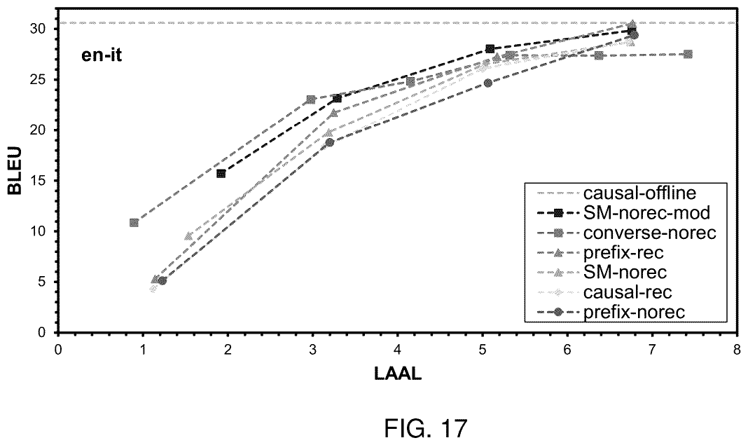

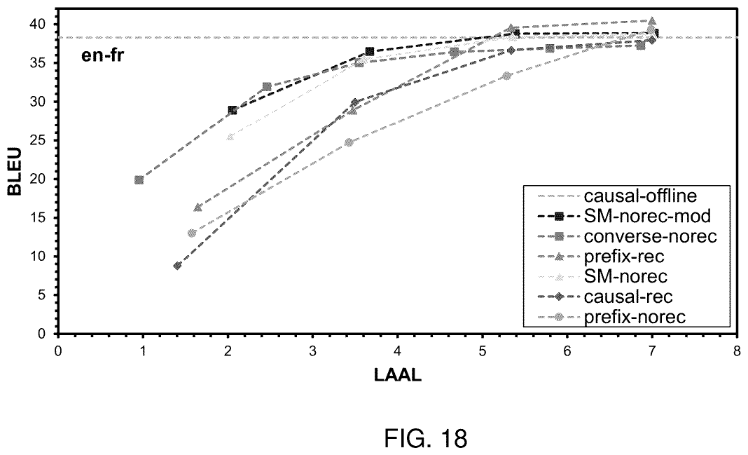

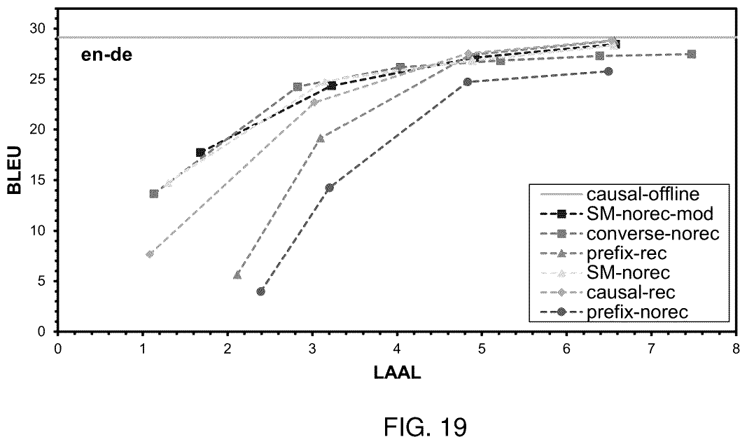

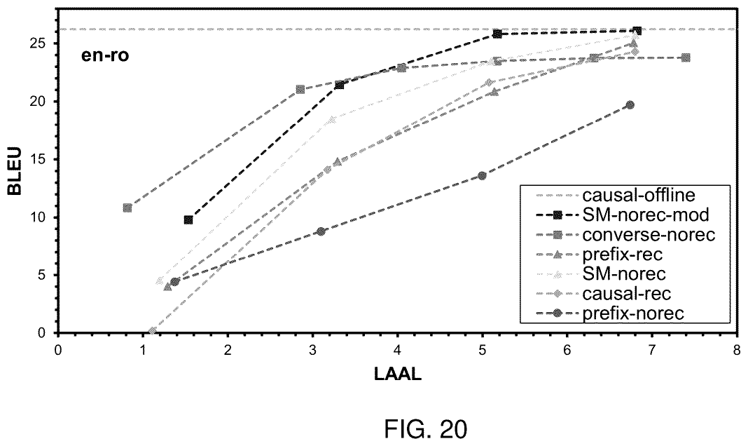

The experiments demonstrate the efficacy of fine-tuning with the proposed SimulMask compared with other schemes using BLEU scores and LAAL. All wait-k model evaluations are performed across wait-{1,3,5,7}, and the converse-norec is evaluated for a chunk size of 1, 3, 5, 7, 9, and 11. FIGS. 16-20 provide the translation quality and latency results on the English-Dutch, English-Italian, English-French, English-German, and English-Romanian language pairs, respectively. Overall, FIGS. 16-20 show that the SM-norec-mod outperforms or matches the translation quality of causal-rec, prefix-rec, and converse-norec across all latencies.

Furthermore, FIGS. 16-18 provide two ablation studies. The first ablation demonstrates the importance of modifying ALiBi with Simul-Mask for high-quality translations by comparing SM-norec-mod with SM-norec. For each wait-k value and language pair, SM-norec-mod outperforms SM-norec. At higher wait-k values where the setting approaches neural machine translation, the difference in BLEU scores becomes less pronounced between the models. A secondary ablation is provided in FIGS. 16-18 by comparing prefix-rec and prefix-norec. Doing so demonstrates that translation quality increases by recomputing the KV cache across all wait-k values. Similarly, as with the previous ablation, the difference in the BLEU score becomes less pronounced for the higher wait-k values.

Another observation is that models evaluated at lower wait-k values have their LAAL deviate from their respective k to a greater degree than those evaluated at higher wait-k. Such an increase is a byproduct of the lower wait-k models generating longer predictions than their corresponding references. The increased generation length is a byproduct of the model hallucinating on sequences provided insufficient contexts.

### Example Experimental Results: Computation Savings

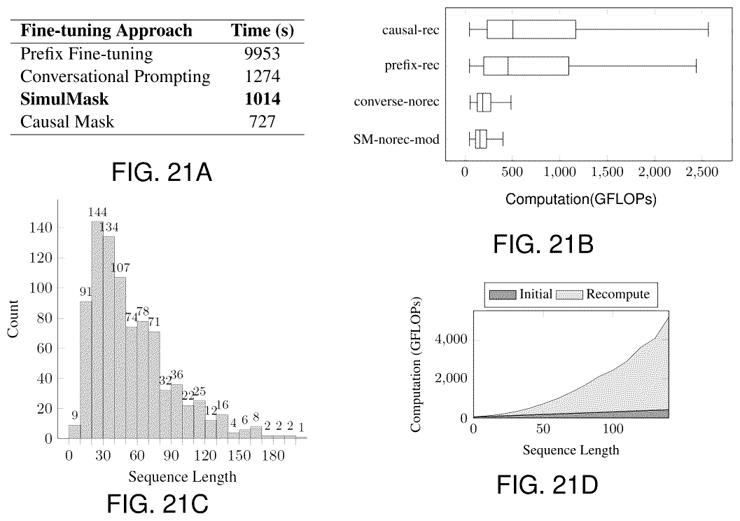

Fine-tuning LLMs with SimulMask also features reduced training time compared with LLMs leveraging prefix fine-tuning or conversational prompting. For instance, this is reflected in the fine-tuning times for one epoch on an H100 GPU on the English-French dataset of the IWSLT 2017 dataset, as shown in the table of FIG. 21A.

Furthermore, it was found that SM-norec is also more computationally efficient at inference than prefixrec and converse-norec. FIG. 21B shows these results in GFLOPs that are needed to complete a sentence translation. The data used to obtain the results was a random 1000 samples from the English-French split of the IWSLT 2017 test set. The models chosen either used wait-3 or a chunk size of 5.

As an example, FIG. 21C shows the number of occurrences on the English-French IWSLT2017 validation set that the combined length of the source sequence and the predicted target sequence are within a specified range for prefix-rec at wait-3.

By leveraging SimulMask during fine-tuning, the need to recompute the KV cache at inference is avoided. In doing so, SimulMask saves computation compared to prefix-rec and causal-rec. FIG. 21D demonstrates the proportions of computation in GFLOPs dedicated to re-computing the KV cache and processing/predicting initial tokens (based on prefix-rec). The sequence length is the number of tokens in the predicted target and input source. As can be seen, it is critical to avoid recomputing KV cache, as achieved by SimulMask, to provide low latency translations, especially at longer sequence lengths.

### Example Computing Systems

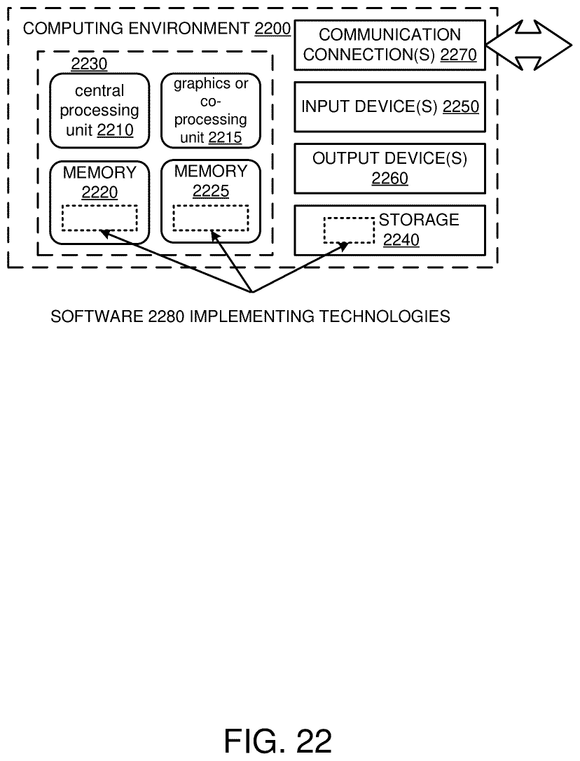

FIG. 22 depicts another example of a suitable computing system 2200 in which the described innovations can be implemented. The computing system 2200 is not intended to suggest any limitation as to scope of use or functionality of the present disclosure, as the innovations can be implemented in diverse computing systems.

With reference to FIG. 22, the computing system 2200 includes one or more processing units 2210, 2215 and memory 2220, 2225. In FIG. 22, this basic configuration 2230 is included within a dashed line. The processing units 2210, 2215 can execute computer-executable instructions, such as for implementing the methods described in the examples herein. A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 22 shows a central processing unit 2210 as well as a graphics processing unit or co-processing unit 2215. The tangible memory 2220, 2225 can be volatile memory (e.g., registers, cache, RAM), non-volatile memory (e.g., ROM, EEPROM, flash memory, etc.), or some combination of the two, accessible by the processing unit(s) 2210, 2215. The memory 2220, 2225 can store software 2280 implementing one or more innovations described herein, in the form of computer-executable instructions suitable for execution by the processing unit(s) 2210, 2215.

A computing system 2200 can have additional features. For example, the computing system 2200 can include storage 2240, one or more input devices 2250, one or more output devices 2260, and one or more communication connections 2270, including input devices, output devices, and communication connections for interacting with a user. An interconnection mechanism (not shown) such as a bus, controller, or network can interconnect the components of the computing system 2200. Typically, operating system software (not shown) can provide an operating environment for other software executing in the computing system 2200, and coordinate activities of the components of the computing system 2200.

The tangible storage 2240 can be removable or non-removable, and includes magnetic disks, magnetic tapes or cassettes, CD-ROMs, DVDs, or any other medium which can be used to store information in a non-transitory way and which can be accessed within the computing system 2200. The storage 2240 can store instructions for the software implementing one or more innovations described herein.

The input device(s) 2250 can be an input device such as a keyboard, mouse, pen, or trackball, a voice input device, a scanning device, touch device (e.g., touchpad, display, or the like) or another device that provides input to the computing system 2200. The output device(s) 2260 can be a display, printer, speaker, CD-writer, or another device that provides output from the computing system 2200.

The communication connection(s) 2270 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

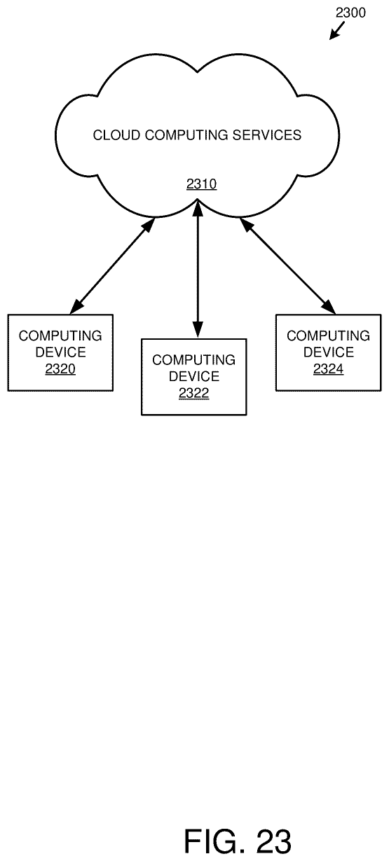

FIG. 23 depicts an example cloud computing environment 2300 in which the described technologies can be implemented, including, e.g., the system and other systems herein. The cloud computing environment 2300 can include cloud computing services 2310. The cloud computing services 2310 can comprise various types of cloud computing resources, such as computer servers, data storage repositories, networking resources, etc. The cloud computing services 2310 can be centrally located (e.g., provided by a data center of a business or organization) or distributed (e.g., provided by various computing resources located at different locations, such as different data centers and/or located in different cities or countries).

The cloud computing services 2310 can be utilized by various types of computing devices (e.g., client computing devices), such as computing devices 2320, 2322, and 2324. For example, the computing devices (e.g., 2320, 2322, and 2324) can be computers (e.g., desktop or laptop computers), mobile devices (e.g., tablet computers or smart phones), or other types of computing devices. For example, the computing devices (e.g., 2320, 2322, and 2324) can utilize the cloud computing services 2310 to perform computing operations (e.g., data processing, data storage, and the like).

In practice, cloud-based, on-premises-based, or hybrid scenarios can be supported.

### EXAMPLE IMPLEMENTATIONS

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### EXAMPLE CLAUSES

Any of the following clauses can be implemented.

Clause 1. A computing system for fine-tuning an autoregressive large language model (LLM) for simultaneous translation, comprising: memory; one or more hardware processors coupled to the memory; and one or more non-transitory computer readable storage media storing instructions that, when loaded into the memory, cause the one or more hardware processors to perform operations comprising: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: obtaining a plurality of queries and a plurality of keys respectively corresponding to the plurality of tokens in the input vector; generating an L×L attention matrix, wherein L represents a dimension of the input vector, wherein the attention matrix comprises attentions calculated as dot products of the plurality of queries and the plurality of keys; and applying an attention mask to the attention matrix, wherein the attention mask is configured to mask selected attentions from the attention matrix based on a read-write decision policy, wherein the read-write decision policy specifies how many source tokens need to be read before writing a target token when using the autoregressive LLM at inference for simultaneous translation, wherein the selected attentions identify tokens in the input vector that would not be available for predicting target tokens when using the autoregressive LLM at inference for simultaneous translation from the source sequence to the target sequence according to the read-write decision policy.

Clause 2. The computing system of clause 1, wherein generating the attention mask comprises: constructing a causal attention mask defined by an L×L matrix M, wherein an entry, Mᵢⱼ, of the matrix M is determined by

$${M}_{ij} = \{ \begin{matrix}0 , & if j \leq i \\ - inf , & otherwise\end{matrix} ,$$

wherein −inf is a predefined negative number indicating negative infinity; and modifying the causal attention mask based on the read-write decision policy.

Clause 3. The computing system of clause 2, wherein modifying the causal attention mask comprises identifying a sub-matrix within the causal attention mask, wherein a position of the sub-matrix within the causal attention mask is determined based on (a) a query predicting a first target token and (b) a key corresponding to a first source token.

Clause 4. The computing system of clause 3, wherein modifying the causal attention mask further comprises: replacing the sub-matrix of the causal attention mask with a sub-attention mask defined by an S×T matrix M′, wherein S is a count of the source tokens in the input vector and Tis a count of the target tokens in the input vector, wherein an entry,

$${M}_{tj}^{′} ,$$

of the matrix M′ is determined by

$${M}_{tj}^{′} = \{ \begin{matrix}0 , & if j \leq f ( t ) \\ - inf , & otherwise\end{matrix} ,$$

wherein f(t) is a function defining the read-write decision policy and denotes a cumulative number of source tokens to read when predicting a target token t.

Clause 5. The computing system of clause 4, wherein the prompt comprises an end prompt token and one or more leading prompt tokens before the end prompt token, wherein the query predicting the first target token corresponds to the end prompt token, wherein modifying the causal attention mask further comprises: identifying one or more rows above the sub-matrix that correspond to the one or more leading prompt tokens; and copying entries from a top row of the sub-attention mask to corresponding columns in the one or more rows above the sub-matrix.

Clause 6. The computing system of any one of clauses 4-5, wherein training the autoregressive LLM further comprises applying static biases to the attention matrix, wherein for an i-th row of the attention matrix, the static biases are initialized as a row vector whose values linearly increase from left to right.

Clause 7. The computing system of clause 6, wherein training the autoregressive LLM further comprises adjusting the static biases, wherein the adjusting comprises: for each row of the attention matrix having one or more attentions to be masked by the sub-attention mask, the static biases initialized for attentions that are left of the one or more masked attentions are offset based on a count of the one or more masked attentions in the row.

Clause 8. The computing system of any one of clauses 1-7, wherein training the autoregressive LLM further comprises: obtaining a plurality of values corresponding to the plurality of tokens in the input vector; calculating a plurality of attention weights based on the attention matrix and the attention mask; and determining a weighted sum of the plurality of values, wherein the plurality of attention weights is respectively assigned to the plurality of values.

Clause 9. The computing system of any one of clauses 1-8, wherein the read-write decision policy is a wait-k decision policy, wherein k is an integer representing a count of source tokens that must be read before a target token can be generated when using the autoregressive LLM for simultaneous translation.

Clause 10. A computer-implemented method for fine-tuning an autoregressive large language model (LLM) for simultaneous translation, the method comprising: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: obtaining a plurality of queries and a plurality of keys respectively corresponding to the plurality of tokens in the input vector; generating an L×L attention matrix, wherein L represents a dimension of the input vector, wherein the attention matrix comprises attentions calculated as dot products of the plurality of queries and the plurality of keys; and applying an attention mask to the attention matrix, wherein the attention mask is configured to mask selected attentions from the attention matrix based on a read-write decision policy, wherein the read-write decision policy specifies how many source tokens need to be read before writing a target token when using the autoregressive LLM at inference for simultaneous translation, wherein the selected attentions identify tokens in the input vector that would not be available for predicting target tokens when using the autoregressive LLM at inference for simultaneous translation from the source sequence to the target sequence according to the read-write decision policy.

Clause 11. The method of clause 10, wherein generating the attention mask comprises: constructing a causal attention mask defined by an L×L matrix M, wherein an entry, Mᵢⱼ, of the matrix M is determined by

$${M}_{ij} = \{ \begin{matrix}0 , & if j \leq i \\ - inf , & otherwise\end{matrix} ,$$

wherein −inf is a predefined negative number indicating negative infinity; and modifying the causal attention mask based on the read-write decision policy.

Clause 12. The method of clause 11, wherein modifying the causal attention mask comprises identifying a sub-matrix within the causal attention mask, wherein a position of the sub-matrix within the causal attention mask is determined based on (a) a query predicting a first target token and (b) a key corresponding to a first source token.

Clause 13. The method of clause 12, wherein modifying the causal attention mask further comprises: replacing the sub-matrix of the causal attention mask with a sub-attention mask defined by an S×T matrix M′, wherein S is a count of the source tokens in the input vector and Tis a count of the target tokens in the input vector, wherein an entry,

$${M}_{tj}^{′} ,$$

of the matrix M′ is determined by

$${M}_{tj}^{′} = \{ \begin{matrix}0 , & if j \leq f ( t ) \\ - inf , & otherwise\end{matrix} ,$$

wherein f(t) is a function defining the read-write decision policy and denotes a cumulative number of source tokens to read when predicting a target token t.

Clause 14. The method of clause 13, wherein the prompt comprises an end prompt token and one or more leading prompt tokens before the end prompt token, wherein the query predicting the first target token corresponds to the end prompt token, wherein modifying the causal attention mask further comprises: identifying one or more rows above the sub-matrix that correspond to the one or more leading prompt tokens; and copying entries from a top row of the sub-attention mask to corresponding columns in the one or more rows above the sub-matrix.

Clause 15. The method of any one of clauses 13-14, wherein training the autoregressive LLM further comprises applying static biases to the attention matrix, wherein for an i-th row of the attention matrix, the static biases are initialized as a row vector whose values linearly increase from left to right.

Clause 16. The method of clause 15, wherein training the autoregressive LLM further comprises adjusting the static biases, wherein the adjusting comprises: for each row of the attention matrix having one or more attentions to be masked by the sub-attention mask, the static biases initialized for attentions that are left of the one or more masked attentions are offset based on a count of the one or more masked attentions in the row.

Clause 17. The method of any one of clauses 10-16, wherein training the autoregressive LLM further comprises: obtaining a plurality of values corresponding to the plurality of tokens in the input vector; calculating a plurality of attention weights based on the attention matrix and the attention mask; and determining a weighted sum of the plurality of values, wherein the plurality of attention weights is respectively assigned to the plurality of values.

Clause 18. The method of any one of clauses 10-17, wherein the read-write decision policy is a wait-k decision policy, wherein k is an integer representing a count of source tokens that must be read before a target token can be generated when using the autoregressive LLM for simultaneous translation.

Clause 19. One or more non-transitory computer-readable media having encoded thereon computer-executable instructions causing one or more processors to perform a method for fine-tuning an autoregressive large language model (LLM) for simultaneous translation, the method comprising: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on self-attention mechanism, comprising: obtaining a plurality of queries and a plurality of keys respectively corresponding to the plurality of tokens in the input vector; generating an L×L attention matrix, wherein Z represents a dimension of the input vector, wherein the attention matrix comprises attentions calculated as dot products of the plurality of queries and the plurality of keys; and applying an attention mask to the attention matrix, wherein the attention mask is configured to mask selected attentions from the attention matrix based on a read-write decision policy, wherein the read-write decision policy specifies how many source tokens need to be read before writing a target token when using the autoregressive LLM at inference for simultaneous translation, wherein the selected attentions identify tokens in the input vector that would not be available for predicting target tokens when using the autoregressive LLM at inference for simultaneous translation from the source sequence to the target sequence according to the read-write decision policy.

Clause 20. The one or more non-transitory computer-readable media of clause 19, wherein the read-write decision policy is a wait-k decision policy, wherein k is an integer representing a count of source tokens that must be read before a target token can be generated when using the autoregressive LLM for simultaneous translation.

Clause 21. A computing system for fine-tuning an autoregressive large language model (LLM) for simultaneous translation, comprising: memory; one or more hardware processors coupled to the memory; and one or more non-transitory computer readable storage media storing instructions that, when loaded into the memory, cause the one or more hardware processors to perform operations comprising: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: generating an attention matrix comprising attentions obtained based on a plurality of queries and a plurality of keys derived from the input vector; applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and applying biases to attentions in the attention mask corresponding to no-mask indicators in the attention mask, wherein for each row of the attention matrix, the biases that are applied to attentions corresponding to no-mask indicators exhibits a linear increase from left to right.

Clause 22. The computing system of clause 21, wherein training the autoregressive LLM further comprises generating the attention mask, comprising: initializing the attention mask as a causal attention mask where all entries above the main diagonal are set to the mask indicator and all entries on or below the main diagonal are set to the no-mask indicator; and changing selected entries below the main diagonal from the no-mask indicator to the mask indicator according to a read-write decision policy, wherein the read-write decision policy specifies how many source tokens need to be read before writing a target token when using the autoregressive LLM at inference for simultaneous translation.

Clause 23. The computing system of clause 22, wherein the changing comprises identifying a sub-matrix within the causal attention mask, wherein a position of the sub-matrix is determined based on (a) a query predicting a first target token and (b) a key corresponding to a first source token.

Clause 24. The computing system of clause 23, wherein the changing further comprises replacing the sub-matrix with a sub-attention mask, wherein one or more entries at a top-right corner region of the sub-attention mask have the mask indicator while remaining entries of the sub-attention mask have the no-mask indicator.

Clause 25. The computing system of clause 24, wherein the changing further comprises generating the sub-attention mask based on the read-write decision policy, wherein the one or more entries at the top-right corner region of the sub-attention mask identifies tokens in the input vector that would not be available for predicting target tokens when using the autoregressive LLM at inference for simultaneous translation from the source sequence to the target sequence according to the read-write decision policy.

Clause 26. The computing system of any one of clauses 24-25, wherein the prompt comprises an end prompt token and one or more leading prompt tokens before the end prompt token, wherein the query predicting the first target token is derived from the end prompt token, wherein the changing further comprises: identifying one or more rows above the sub-matrix that correspond to the one or more leading prompt tokens; and copying entries from a top row of the sub-attention mask to corresponding columns in the one or more rows above the sub-matrix.

Clause 27. The computing system of any one of clauses 21-26, wherein the self-attention mechanism is configured to: calculate a plurality of attention weights based on the attention matrix, the attention mask, and the biases; and determine a weighted sum of a plurality of values derived from the input vector, wherein the plurality of attention weights is respectively assigned to the plurality of values.

Clause 28. The computing system of any one of clauses 21-27, wherein attentions in the attention matrix are calculated as dot products of the plurality of queries and the plurality of keys, wherein applying the attention mask comprises adding the attention mask to the attention matrix, wherein the mask indicator is a predefined negative number indicating negative infinity, and the no-mask indicator is zero.

Clause 29. The computing system of any one of clauses 21-28, wherein the self-attention mechanism comprises a multi-head self-attention neural network, wherein the biases applied in each head of the self-attention neural network are defined by a head-specific scale which determines a slope of the linear increase.

Clause 30. A computer-implemented method for fine-tuning an autoregressive large language model (LLM) for simultaneous translation, the method comprising: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: generating an attention matrix comprising attentions obtained based on a plurality of queries and a plurality of keys derived from the input vector; applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and applying biases to attentions in the attention mask corresponding to no-mask indicators in the attention mask, wherein for each row of the attention matrix, the biases that are applied to attentions corresponding to no-mask indicators exhibits a linear increase from left to right.

Clause 31. The method of clause 30, wherein training the autoregressive LLM further comprises generating the attention mask, comprising: initializing the attention mask as a causal attention mask where all entries above the main diagonal are set to the mask indicator and all entries on or below the main diagonal are set to the no-mask indicator; and changing selected entries below the main diagonal from the no-mask indicator to the mask indicator according to a read-write decision policy, wherein the read-write decision policy specifies how many source tokens need to be read before writing a target token when using the autoregressive LLM at inference for simultaneous translation.

Clause 32. The method of clause 31, wherein the changing comprises identifying a sub-matrix within the causal attention mask, wherein a position of the sub-matrix is determined based on (a) a query predicting a first target token and (b) a key corresponding to a first source token.

Clause 33. The method of clause 32, wherein the changing further comprises replacing the sub-matrix with a sub-attention mask, wherein one or more entries at a top-right corner region of the sub-attention mask have the mask indicator while remaining entries of the sub-attention mask have the no-mask indicator.

Clause 34. The method of clause 33, wherein the changing further comprises generating the sub-attention mask based on the read-write decision policy, wherein the one or more entries at the top-right corner region of the sub-attention mask identifies tokens in the input vector that would not be available for predicting target tokens when using the autoregressive LLM at inference for simultaneous translation from the source sequence to the target sequence according to the read-write decision policy.

Clause 35. The method of any one of clauses 33-34, wherein the prompt comprises an end prompt token and one or more leading prompt tokens before the end prompt token, wherein the query predicting the first target token is derived from the end prompt token, wherein the changing further comprises: identifying one or more rows above the sub-matrix that correspond to the one or more leading prompt tokens; and copying entries from a top row of the sub-attention mask to corresponding columns in the one or more rows above the sub-matrix.

Clause 36. The method of any one of clauses 30-35, wherein the self-attention mechanism is configured to calculate a plurality of attention weights based on the attention matrix, the attention mask, and the biases; and determine a weighted sum of a plurality of values derived from the input vector, wherein the plurality of attention weights is respectively assigned to the plurality of values.

Clause 37. The method of any one of clauses 30-36, wherein attentions in the attention matrix are calculated as dot products of the plurality of queries and the plurality of keys, wherein applying the attention mask comprises adding the attention mask to the attention matrix, wherein the mask indicator is a predefined negative number indicating negative infinity, and the no-mask indicator is zero.

Clause 38. The method of any one of clauses 30-37, wherein the self-attention mechanism comprises a multi-head self-attention neural network, wherein the biases applied in each head of the self-attention neural network are defined by a head-specific scale which determines a slope of the linear increase.

Clause 39. One or more non-transitory computer-readable media having encoded thereon computer-executable instructions causing one or more processors to perform a method for fine-tuning an autoregressive large language model (LLM) for simultaneous translation, the method comprising: receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and training the autoregressive LLM using the input vector based on a self-attention mechanism, comprising: generating an attention matrix comprising attentions obtained based on a plurality of queries and a plurality of keys derived from the input vector; applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and applying biases to attentions in the attention mask corresponding to no-mask indicators in the attention mask, wherein for each row of the attention matrix, the biases that are applied to attentions corresponding to no-mask indicators exhibits a linear increase from left to right.

Clause 40. The one or more non-transitory computer-readable media of claim 39, wherein the self-attention mechanism comprises a multi-head self-attention neural network, wherein the biases applied in each head of the self-attention neural network are defined by a head-specific scale which determines a slope of the linear increase.

The technologies from any clause can be combined with the technologies described in any one or more of the other clauses.

In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system for fine-tuning an autoregressive large language model (LLM) for simultaneous translation, comprising:
memory;
one or more hardware processors coupled to the memory; and
one or more non-transitory computer readable storage media storing instructions that, when loaded into the memory, cause the one or more hardware processors to perform operations comprising:
receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and
training the autoregressive LLM using the input vector based on a self-attention mechanism, comprising:
generating an attention matrix comprising attentions obtained based on a plurality of queries and a plurality of keys derived from the input vector;
applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and
applying biases to attentions in the attention mask corresponding to no-mask indicators in the attention mask,
wherein for each row of the attention matrix, the biases that are applied to attentions corresponding to no-mask indicators exhibits a linear increase from left to right.

2. The computing system of claim 1, wherein training the autoregressive LLM further comprises generating the attention mask, comprising:
initializing the attention mask as a causal attention mask where all entries above the main diagonal are set to the mask indicator and all entries on or below the main diagonal are set to the no-mask indicator; and
changing selected entries below the main diagonal from the no-mask indicator to the mask indicator according to a read-write decision policy,
wherein the read-write decision policy specifies how many source tokens need to be read before writing a target token when using the autoregressive LLM at inference for simultaneous translation.

3. The computing system of claim 2, wherein the changing comprises identifying a sub-matrix within the causal attention mask,
wherein a position of the sub-matrix is determined based on (a) a query predicting a first target token and (b) a key corresponding to a first source token.

4. The computing system of claim 3, wherein the changing further comprises replacing the sub-matrix with a sub-attention mask, wherein one or more entries at a top-right corner region of the sub-attention mask have the mask indicator while remaining entries of the sub-attention mask have the no-mask indicator.

5. The computing system of claim 4, wherein the changing further comprises generating the sub-attention mask based on the read-write decision policy, wherein the one or more entries at the top-right corner region of the sub-attention mask identifies tokens in the input vector that would not be available for predicting target tokens when using the autoregressive LLM at inference for simultaneous translation from the source sequence to the target sequence according to the read-write decision policy.

6. The computing system of claim 4, wherein the prompt comprises an end prompt token and one or more leading prompt tokens before the end prompt token, wherein the query predicting the first target token is derived from the end prompt token, wherein the changing further comprises:
identifying one or more rows above the sub-matrix that correspond to the one or more leading prompt tokens; and
copying entries from a top row of the sub-attention mask to corresponding columns in the one or more rows above the sub-matrix.

7. The computing system of claim 1, wherein the self-attention mechanism is configured to:
calculate a plurality of attention weights based on the attention matrix, the attention mask, and the biases; and
determine a weighted sum of a plurality of values derived from the input vector, wherein the plurality of attention weights is respectively assigned to the plurality of values.

8. The computing system of claim 1, wherein attentions in the attention matrix are calculated as dot products of the plurality of queries and the plurality of keys, wherein applying the attention mask comprises adding the attention mask to the attention matrix, wherein the mask indicator is a predefined negative number indicating negative infinity, and the no-mask indicator is zero.

9. The computing system of claim 1, wherein the self-attention mechanism comprises a multi-head self-attention neural network, wherein the biases applied in each head of the self-attention neural network are defined by a head-specific scale which determines a slope of the linear increase.

10. A computer-implemented method for fine-tuning an autoregressive large language model (LLM) for simultaneous translation, the method comprising:
receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and
training the autoregressive LLM using the input vector based on a self-attention mechanism, comprising:
generating an attention matrix comprising attentions obtained based on a plurality of queries and a plurality of keys derived from the input vector;
applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and
applying biases to attentions in the attention mask corresponding to no-mask indicators in the attention mask,
wherein for each row of the attention matrix, the biases that are applied to attentions corresponding to no-mask indicators exhibits a linear increase from left to right.

11. The method of claim 10, wherein training the autoregressive LLM further comprises generating the attention mask, comprising:
initializing the attention mask as a causal attention mask where all entries above the main diagonal are set to the mask indicator and all entries on or below the main diagonal are set to the no-mask indicator; and
changing selected entries below the main diagonal from the no-mask indicator to the mask indicator according to a read-write decision policy,
wherein the read-write decision policy specifies how many source tokens need to be read before writing a target token when using the autoregressive LLM at inference for simultaneous translation.

12. The method of claim 11, wherein the changing comprises identifying a sub-matrix within the causal attention mask,
wherein a position of the sub-matrix is determined based on (a) a query predicting a first target token and (b) a key corresponding to a first source token.

13. The method of claim 12, wherein the changing further comprises replacing the sub-matrix with a sub-attention mask, wherein one or more entries at a top-right corner region of the sub-attention mask have the mask indicator while remaining entries of the sub-attention mask have the no-mask indicator.

14. The method of claim 13, wherein the changing further comprises generating the sub-attention mask based on the read-write decision policy, wherein the one or more entries at the top-right corner region of the sub-attention mask identifies tokens in the input vector that would not be available for predicting target tokens when using the autoregressive LLM at inference for simultaneous translation from the source sequence to the target sequence according to the read-write decision policy.

15. The method of claim 13, wherein the prompt comprises an end prompt token and one or more leading prompt tokens before the end prompt token, wherein the query predicting the first target token is derived from the end prompt token, wherein the changing further comprises:
identifying one or more rows above the sub-matrix that correspond to the one or more leading prompt tokens; and
copying entries from a top row of the sub-attention mask to corresponding columns in the one or more rows above the sub-matrix.

16. The method of claim 10, wherein the self-attention mechanism is configured to calculate a plurality of attention weights based on the attention matrix, the attention mask, and the biases; and
determine a weighted sum of a plurality of values derived from the input vector, wherein the plurality of attention weights is respectively assigned to the plurality of values.

17. The method of claim 10, wherein attentions in the attention matrix are calculated as dot products of the plurality of queries and the plurality of keys, wherein applying the attention mask comprises adding the attention mask to the attention matrix, wherein the mask indicator is a predefined negative number indicating negative infinity, and the no-mask indicator is zero.

18. The method of claim 10, wherein the self-attention mechanism comprises a multi-head self-attention neural network, wherein the biases applied in each head of the self-attention neural network are defined by a head-specific scale which determines a slope of the linear increase.

19. One or more non-transitory computer-readable media having encoded thereon computer-executable instructions causing one or more processors to perform a method for fine-tuning an autoregressive large language model (LLM) for simultaneous translation, the method comprising:
receiving an input vector comprising a plurality of tokens including one or more source tokens, a prompt following the one or more source tokens, and one or more target tokens following the prompt, wherein the one or more source tokens represent a source sequence, and the one or more target tokens represent a target sequence translated from the source sequence; and
training the autoregressive LLM using the input vector based on a self-attention mechanism, comprising:
generating an attention matrix comprising attentions obtained based on a plurality of queries and a plurality of keys derived from the input vector;
applying an attention mask to the attention matrix, wherein all entries above and zero or more entries below a main diagonal of the attention mask have a mask indicator indicating corresponding attentions in the attention mask are masked, while all remaining entries of the attention mask have a no-mask indicator indicating corresponding attentions in the attention mask are not masked; and
applying biases to attentions in the attention mask corresponding to no-mask indicators in the attention mask,
wherein for each row of the attention matrix, the biases that are applied to attentions corresponding to no-mask indicators exhibits a linear increase from left to right.

20. The one or more non-transitory computer-readable media of claim 19, wherein the self-attention mechanism comprises a multi-head self-attention neural network, wherein the biases applied in each head of the self-attention neural network are defined by a head-specific scale which determines a slope of the linear increase.
